(19) United States
(12) Patent Application Publication
(10) Pub. No.: US 2022/0284340 A1
(43) Pub. Date: Sep. 8, 2022

(54) DETERMINING DIGITAL PERSONAS UTILIZING DATA-DRIVEN ANALYTICS

(71) Applicant: Adobe Inc., San Jose, CA (US)

(72) Inventors: Gautam Choudhary, Sri Ganganagar (IN); Iftikhar Ahamath Burhanuddin, Bangalore (IN)

(21) Appl. No.: 17/189,681

(22) Filed: Mar. 2, 2021

(51) Int. Cl. G06N 20/00; G06F 11/34; G06F 16/901; G06F 16/906; G06K 9/62

(52) U.S. Cl. CPC G06N 20/00; G06F 11/3438; G06F 16/9024; G06F 16/906; G06K 9/6218

(57) ABSTRACT

The present disclosure relates to systems, non-transitory computer-readable media, and methods that utilize a data-driven approach to organize user-activity data for a user into a hierarchy of digital actions, digital tasks, and digital workflows and categorize a vector representing frequent activities from the hierarchy into a persona group for the user. From this vector representation, the disclosed systems can categorize the vector representation from among a distribution of other vector representations for other users into a persona group for the particular user. Based on at least one of the determined persona group or the vector representation, the disclosed systems can use a nodal graph to determine a digital recommendation that the particular user collaborate with other users or collaborate on a particular project.

### BACKGROUND

In recent years, engineers have improved software platforms to better extract insights from digital user data. For example, some clustering systems identify segments of users that share common characteristics based on user data. To illustrate, certain conventional clustering systems utilize machine-learning models that perform complex analyses to predict user segments. In yet other cases, some conventional clustering systems use computer code reflecting domain knowledge to build user segments and track evolving user populations across user segments. But such conventional clustering systems can inordinately consume both processing power and time when executing machine-learning functions to form clusters and can inflexibly require input of data reflecting technical or complex domain knowledge.

In addition to existing clustering systems, some existing analytics recommendation systems analyze user data and predict (or infer) relationships within an organization or digital content of interest to users. For instance, traditional analytics recommendation systems conduct extensive surveys to gather user data (e.g., to generate recommendations about work projects, personnel, or digital content). But these conventional analytics recommendation systems also suffer from a number of technical deficiencies. Independent of common errors from machine-learning models recommending irrelevant content, for example, some conventional analytics recommendation systems provide inaccurate recommendations for videos or other digital content based on faulty inferences the machine-learning model may be trained to draw by itself—regardless of whether the machine-learning model was trained using surveys or not.

In some cases, a larger system uses both analytics recommendation systems and clustering systems together as subsystems to, for instance, generate digital-content recommendations to user segments. Nevertheless, these larger systems can suffer the same technical shortcomings mentioned above.

### BRIEF SUMMARY

This disclosure describes embodiments of systems, non-transitory computer-readable media, and methods that solve one or more of the foregoing problems in the art or provide other benefits described herein. In particular, the disclosed systems utilize a data-driven approach to organize user-activity data for a user into a hierarchy of digital actions, digital tasks, and digital workflows performed by the user and categorize a vector representing frequent digital actions, frequent digital tasks, and frequent digital workflows from the hierarchy into a persona group for the user. For instance, in some embodiments, the disclosed systems extract sessionized data from an activity log to generate a hierarchy of digital actions, digital tasks, and digital workflows for the user. The disclosed systems further generate a vector representation of frequent digital actions, frequent digital tasks, and frequent digital workflows. From this vector representation, the disclosed systems can categorize the vector representation from among a distribution of other vector representations for other users into a persona group for the particular user. Based on at least the determined persona group or the vector representation, the disclosed systems can use a nodal graph to determine a digital recommendation concerning the particular user, such as a recommendation for the user to collaborate with other users or to collaborate on a particular project.

This disclosure outlines additional features and advantages of one or more embodiments of the present disclosure in the following description.

### BRIEF DESCRIPTION OF THE DRAWINGS

The detailed description provides one or more embodiments with additional specificity and detail through the use of the accompanying drawings, as briefly described below.

FIG. 1 illustrates a computing system environment for implementing a persona group system in accordance with one or more embodiments.

FIG. 2 illustrates a persona group system determining a persona group for a user in accordance with one or more embodiments.

FIGS. 3A-3B illustrate a persona group system utilizing a data-mining function to generate a hierarchy of digital actions, digital tasks, and digital workflows in accordance with one or more embodiments.

FIG. 4 illustrates a persona group system utilizing a clustering model to determine a persona group in accordance with one or more embodiments.

FIGS. 5A-5B illustrate a persona group system generating a digital recommendation in accordance with one or more embodiments.

FIGS. 6A-6B illustrate a persona group system generating respective digital recommendations in the form of a persona heat map and a frequency plot in accordance with one or more embodiments.

FIG. 7 illustrates a persona group system providing a user interface on a computing device depicting a digital recommendation in accordance with one or more embodiments.

FIG. 8 illustrates an example schematic diagram of a persona group system in accordance with one or more embodiments.

FIG. 9 illustrates a flowchart of a series of acts for determining a persona group for a user in accordance with one or more embodiments.

FIG. 10 illustrates a block diagram of an example computing device for implementing one or more embodiments of the present disclosure.

### DETAILED DESCRIPTION

This disclosure describes one or more embodiments of a persona group system that determines a hierarchy of digital actions, digital tasks, and digital workflows performed by a user from the user's activity data and categorizes a vector representing frequent activities from the hierarchy (along with similar vectors for other users) into a persona group for the user. For example, the persona group system uses a data mining function to group particular users' clickstreams into a hierarchy of frequent digital actions, frequent digital tasks, and frequent digital workflows respectively performed by users. After generating a user-activity vector representing such frequent digital actions, tasks, and workflows for users, the persona group system uses a clustering algorithm to cluster user-activity vectors for the users into persona groups. Once clustered into persona groups, the persona group system can recommend that users within the same persona group collaborate together on work projects or target a user in a particular persona group with digital content (e.g., video-streaming content), among various other persona-based-digital recommendations.

To illustrate an implementation of the features described above, in some cases, the persona group system identifies a set of digital actions performed by a user during one or more user sessions. From the set of digital actions, in certain implementations, the persona group system generates a hierarchy by categorizing (i) a set of frequent digital actions performed by the user into a set of digital tasks and (ii) a set of frequent digital tasks performed by the user into a set of digital workflows. From the set of digital workflows, the persona group system further determines a set of frequent digital workflows. The persona group system further generates a user-activity vector representing counts of such frequent digital actions, frequent digital tasks, and frequent digital workflows from the hierarchical categories. Subsequently, the persona group system uses a clustering model to determine a persona group for the user by clustering the user-activity vector for the user with additional user-activity vectors for additional users.

As noted above, in some embodiments, the persona group system implements a data-analytics approach that identifies digital actions across one or more user sessions from user data. For example, as part of a pre-processing step, the persona group system identifies, extracts, filters, and/or stores elements from raw clickstream data, such as timestamps, user identifiers, action labels for digital actions, metadata, etc. In one or more embodiments, the persona group system stores the pre-processed data from the raw clickstream in an analytics database (e.g., for categorizing digital actions and/or generating nodal graphs as described below).

After identifying digital actions from such user data, in particular embodiments, the persona group system categorizes subsets of digital actions into a set of digital tasks and subsets of digital tasks into a set of digital workflows. For example, the persona group system utilizes an itemset mining algorithm to perform at least a multi-step analysis for creating a hierarchy of digital actions, digital tasks, and digital workflows. At an initial analysis step, the persona group system uses the itemset mining algorithm to identify frequent digital actions satisfying a frequency threshold or other support metric. In turn, the persona group system groups subsets of digital actions that frequently co-occur during user sessions into sets of digital tasks. At a subsequent analysis step, the persona group system analyzes the sets of digital tasks utilizing the itemset mining algorithm to identify digital tasks that frequently co-occur during user sessions and satisfy a same or different frequency threshold or other support metric. Then, in certain embodiments, the persona group system groups subsets of digital tasks that frequently co-occur during user sessions into sets of digital workflows.

Based on the hierarchy of digital actions, digital tasks, and digital workflows, in one or more embodiments, the persona group system generates a user-activity vector. For example, the persona group system generates a user-activity vector by aggregating counts of frequent digital actions, frequent digital tasks, and frequent digital workflows across user sessions into a vector. The person group system similarly generates user-activity vectors for additional users.

By using the user-activity vector and a clustering algorithm, in certain embodiments, the persona group system formulates a persona group based on distributions of user-activity vectors for multiple users. For example, in certain implementations, the persona group system maps the user-activity vector to a particular cluster of other user-activity vectors to determine which persona group the user likely belongs.

Based on a persona group for a user, in at least some embodiments, the persona group system generates a digital recommendation concerning the user for presentation within a graphical user interface. For example, the persona group system utilizes a classification model (e.g., a logistic regression model, LightGBM model) to analyze user-activity vectors and/or persona groups to identify an appropriate digital recommendation. Additionally or alternatively, the persona group system uses the classification model to analyze nodal graph vectors (e.g., user graph vectors, project vectors) that represent the nodal elements and structural relations of a nodal graph, such as edge connections between user/project nodes. Based on the analysis, the classification model generates a probability value that the user will form an edge connection in the nodal graph with another user node or project node. In response to a predicted edge formation, in certain implementations, the persona group system surfaces a corresponding digital recommendation concerning the user and the additional user and/or project.

As mentioned above, conventional clustering systems and conventional analytics recommendation systems demonstrate a number of technical problems and shortcomings. For example, some conventional clustering systems require computationally heavy analyses that slow the runtime speed of a computing device that gathers and analyzes user data to generate clusters. To illustrate, some conventional clustering systems utilize deep learning approaches that analyze massive amounts of user data to ascertain user patterns, characteristics, or other variables to infer relationships for a cluster. Although such conventional clustering systems represent diverse features and intricate relationships relating to users, these deep learning approaches typically require larger amounts of computational resources to counter decreased runtime speeds. Therefore, these computational requirements hinder application on some client devices with limited computational resources.

In addition to slow speeds and computationally heavy processing, some conventional clustering systems inflexibly include computer code that relies on user input for particular domain knowledge. For example, to perform feature engineering and extract features from raw data using data mining techniques, such conventional clustering systems often rely on domain knowledge to learn and identify user segments. Without previously incorporating domain knowledge into such feature engineering, some conventional clustering systems cannot generate predictions and classifications for user data with diverse or complex domains (e.g., user data for a biotech industry or other highly technical field or a heavily hierarchical government organization).

Independent of technical limitations of clustering systems, conventional analytics recommendation systems commonly recommend inapplicable or inaccurate digital content relating to users. For example, some conventional analytics recommendation systems rely predominantly on feature representations for nodes in a network. By focusing on nodal structure features, these approaches lack the ability to represent various aspects of user behavior, such as frequently performed digital actions in user sessions. In addition to faulty focus, these conventional analytics recommendation systems often require careful effort in extracting features for a feature engineering process. Such an analytics recommendation system may use a classification model for recommendations that rely on a time-intensive and computing-intensive process to extract features based on specialized domain knowledge. Consequently, myriad user errors in the feature engineering process leads to accuracy issues that percolate into ill-trained learning algorithms. Accordingly, certain conventional systems suffer from decreased accuracy of recommended digital content.

In contrast to the technical limitations summarized above, the persona group system improves the computing speed, accuracy of recommendations, and flexibility across different domains over conventional systems. For example, the persona group system expedites the runtime speed. That is, the persona group system provides a compute-light approach that leverages data analytics to more quickly determines one or both of persona groups and digital recommendations compared to the computation-intense approaches of certain conventional clustering or other systems that utilize machine-learning models. For example, unlike conventional systems, the persona group system generates a hierarchy by categorizing (i) a set of frequent digital actions performed by the user into a set of digital tasks and (ii) a set of frequent digital tasks performed by the user into a set of digital workflows. From the set of digital workflows, the persona group system can further determine a set of frequent digital workflows. In some cases, the persona group system uses data mining to identify such frequent activities to leverage the hierarchy into a vector. By generating such a hierarchy, is the persona group system is faster than certain conventional systems because the persona group system can leverage frequency-based vector representations of the hierarchy elements to quickly cluster a particular user into a predicted persona group.

In addition to improved speed of implementing computing devices, the persona group system can also provide more accurate digital recommendations. For example, in some cases, the persona group system accounts for user behavior by identifying, analyzing, and representing digital actions from a digital action log. Rather than predominantly relying on feature representations for nodes in a network like some conventional analytics recommendation systems, the persona group system can accurately generate classification probabilities that a user will collaborate with an additional user or work on a project by using a classification model that analyzes user-activity vectors and/or persona groups of users. By generating more accurate classification probabilities or confidence values, the persona group system can in turn generate digital recommendations with increased relevancy and accuracy.

Beyond improved runtime speed and accuracy, the persona group system can also increase the flexibility with which conventional analytics recommendation systems or conventional clustering systems operate. For example, the persona group system can operate on numerous domains without requiring prior domain knowledge from being trained on specific domains and/or feature engineering that incorporates specific domain knowledge. Rather than account for domain knowledge, the persona group system can flexibly identify a set of digital actions from a digital action log and correspondingly categorize subsets of digital actions into a set of digital tasks and subsets of digital tasks into a set of digital workflows. From the set of digital workflows, in certain embodiments, the persona group system further determines a set of frequent digital workflows. Indeed, with or without domain knowledge, the persona group system can use the categories to generate user-activity vectors representing frequent digital tasks, frequent digital tasks, and frequent digital workflows for determining a persona group of a user.

As illustrated by the foregoing discussion, the present disclosure utilizes a variety of terms to describe features and benefits of the persona group system. For example, as used herein, the term “persona group” refers to a classification, segment, or category of users. In particular, a persona group can include a class, segment, or category of users represented by a vector. Such a vector may represent one or more digital actions, digital tasks, and digital workflows frequently selected and/or performed by a computing device for a user. In particular embodiments, a persona group may reflect a quantitative relationship between users, such as distances between user-activity vectors. As another quantitative example, a persona group may reflect a group of user-activity vectors that fall within a threshold probability distribution (e.g., two standard deviations) from a distribution center or mean.

To illustrate some examples of a persona group, a persona group can refer to a particular population of users, such as users working with visualizations based on metrics like revenue (e.g., a metric-visualization persona group). As another example, a persona group includes a user segment that investigates data by performing drag-and-drop operations for certain dimensions or metrics (e.g., an investigative-data persona group). In yet another example, a persona group includes a user segment that views reports and interacts with various calculated metrics, such as visits (e.g., a visits-report persona group). As an additional example, a persona group includes a user population of users that create user segments (e.g., a segment-creation persona group). Still, another example of a persona group includes a user segment that shares projects or manages projects (e.g., a project-collaboration persona group).

As also used herein, the term “digital action” refers to an action executed using a computing device. In particular, a digital action can refer to an action performed by a user of a computing device, using functions and features of the computing device. For example, a digital action can include an action related to analyzing digital data (e.g., via an analytics user interface), such as launching a project, dragging-and-dropping one or more components, saving a segment, clicking a node, or calculating a value. However, a digital action can include an action other than those in the context of digital data analysis. For example, a digital action can include an action related to clicking on a toolbar/panel option, executing a “save,” selecting a row/column of data, filtering metrics, downloading a graphical visualization, or performing a drag-and-drop operation.

Relatedly, the term “digital action log” refers to a digital log of digital actions executed by a user. In particular, a digital action log can refer to a digital record that stores digital actions executed by a computing device associated with the user (e.g., in response to input from the user and/or under a user profile/account associated with the user). A digital action log can include a digital record that stores a chronological list of digital actions or otherwise includes a timed record of digital actions selected by a user via one or more platforms, operating systems, computer applications, and/or user interfaces.

Additionally, as used herein, the term “digital task” refers to a plurality of related digital actions performed by a computing device associated with a user based on user input. In particular, a digital task can refer to a discrete computing project or discrete computing job that is completed or performed by a computing device as a result of performance of a plurality of digital actions or that becomes available for completion after performance of the plurality of digital actions. In other words, a digital task can refer to a computing project or job comprising one or more digital actions frequently selected and/or performed to complete (e.g., execute) that project or job. In certain implementations, a digital task comprises a subset of co-occurring (e.g., occurring within a same user session or same portion of a user session) digital actions for a user session. In particular embodiments, the subset of digital actions comprising a digital task are order agnostic and may, for instance, be an identifiable (e.g., numbered) collection of frequently co-occurring digital actions. For example, a digital task can include downloading a report, editing a user segment, or tracking metrics. As another example, a digital task can include generating, viewing, or editing a digital image or digital video or at least a portion of a digital image or a digital video. A digital task can also include conducting a search to review results from a website query or navigating a web site to review constituent webpages.

Further, as used herein, the term “digital workflow” refers to a plurality of related digital tasks performed by a computing device associated with a user based on user input. In particular, a digital workflow can refer to a subset of digital tasks that are frequently performed together. For instance, a digital workflow can refer to a subset of digital tasks frequently performed within a user session. In particular embodiments, the subset of digital tasks comprising a digital workflow are order agnostic and may, for instance, be an identifiable (e.g., numbered) collection of frequently co-occurring digital tasks. For example, a digital workflow can include performance of a common series or collection of digital tasks, such as a subset of digital tasks comprising a task for analyzing digital data, a task for building a segment of users, and a task for generating graphic visualizations.

In addition, as used herein, the terms “multi-level hierarchy” or “hierarchy” refer to a data structure that comprises an organization for multiple levels of data elements or types of data. In particular embodiments, a hierarchy comprises digital actions, digital tasks, and digital workflows in discrete levels or tiers of a digital structure. For example, a hierarchy comprises a base level of frequent digital actions, a middle level of frequent digital tasks, and an upper level of frequent digital workflows. Additionally, for instance, a hierarchy comprises inter-level connections that indicate groupings of frequent digital actions that correspond to a digital task and groupings of frequent digital tasks that correspond to a digital workflow.

As used herein, the term “user-activity vector” refers to a vector representation of user activity on a computing device. In particular, a user-activity vector can include a numerical representation of the number of occurrences or an indication of particular digital actions, particular digital tasks, and particular digital workflows in one or more user sessions. For example, a user-activity vector includes binary values of zeros (“0” to indicate non-occurrence in a user session) and ones (“1” to indicate at least one occurrence) for digital actions, digital tasks, and digital workflows. As another example, a user-activity vector may include a string of integer values representing absolute frequency of digital actions, digital tasks, and digital workflows in one or more user sessions. As another example. Additionally or alternatively, in some embodiments, a user-activity vector represents only frequent digital actions, frequent digital tasks, and/or frequent digital workflows.

As used herein, the term “data-mining function” refers to a data mining algorithm for determining relationships between variables or patterns among variables in datasets. In particular a data-mining function can an algorithm for performing frequent pattern mining to determine patterns that appear frequently within a dataset, for example, as done in certain types of analyses, such as market-based analyses or affinity analyses. For example, a data-mining function can include an itemset mining algorithm, such as association rules, the Apriori algorithm, the Park-Chen-Yu (or PCY) algorithm, prefix-tree structure algorithms (also known as FP-tree based algorithms), or association rule mining.

As also used herein, the term “clustering model” refers to a computational model or algorithm for grouping a larger dataset into subsets of data. In particular embodiments, a clustering model includes a probabilistic model for representing user-activity vectors as a set of normal distributions or clusters as persona groups. Examples of clustering models include a Gaussian mixture model, a K-means clustering model, or a Spectral model.

Additionally, as used herein, the term “digital recommendation” refers to a digital communication or graphical representation suggesting a collaboration, a projection, digital content, or another item for a user. In particular, a digital recommendation can include personalized content (e.g., user-specific content). For example, a digital recommendation can include a user-specific content item, such as a suggested digital template (e.g., a form, outline, or document draft) or a suggested project. Similarly, a digital recommendation can include user-specific content, such as a digital notification (e.g., an informational alert or warning report), an advertisement, or a graphical dashboard (e.g., an evaluation/performance widget, a visualization graphical user interface, or an interactive intranet site). Likewise, a digital recommendation in some cases includes a graphic visualization (e.g., a heat map or frequency plot). As another example, a digital recommendation can include a suggested team of users (e.g., a group or set of users based on persona groups), a suggested collaboration, and/or a suggested privilege (e.g., an edit privilege, a duplicate or save-as privilege, or a view privilege) with respect to a project.

As additionally used herein, the term “classification model” refers to a computational model or algorithm for predicting relationships between digital objects. For instance, a classification model can include a model or an algorithm that predicts edges between nodes within a nodal graph. In particular, a classification model generates classification probabilities (e.g., probability values that new edges will form between nodes within a time period). For instance, a classification model analyzes one or more input vectors, such as a user-activity vector, a project vector (e.g., a numerical representation of a project or project node), and/or a user graph vector (e.g., a numerical representation of user nodes/users and/or structural configurations of user nodes) to generate an edge prediction.

Relatedly, as used herein, the term “nodal graph” refers to a network structure of user nodes (e.g., structural entities representing users) and/or project nodes (e.g., structural entities representing projects). In particular, a nodal graph can include a network structure comprising edges (e.g., links or connections based on relationships) between nodes. For example, an edge between user nodes may represent a shared project between users, transmission of a digital communication between users, a common access privilege between users, etc. As another example, an edge between a user node and a project node may represent a privilege and/or an observed digital action of editing, duplicating, or viewing a project.

As used herein, the term “project” refers to an assignment or enterprise within an organization to achieve a goal or target. In particular embodiments, a project can include or relate to any of a variety of files, folders, workspaces (e.g., a directory of folders and/or files on a memory/storage device accessible by one or more user accounts over a network), websites, software tools, placeholder files, collaborative content items, and the like. For example, a project can include digital marketing campaigns, software code libraries or notebooks, documents, shared files, individual or team (e.g., shared) workspaces, text files (e.g., PDF files, word processing files), audio files, image files, video files, template files, webpages, executable files, binaries, zip files, playlists, albums, email communications, instant messaging communications, social media posts, calendar items, etc.

As used herein, the term “user session” refers to a time period or an instance of executing one or more digital actions. In particular, a user session can refer to a distinct occasion or time period in which a user selects one or more digital actions to execute one or more digital tasks or digital workflows. For example, a user session can refer to an instance of executing a digital task or digital workflow that is distinguishable (e.g., distinct in time) from another instance of executing the same (or a different) digital task or digital workflow.

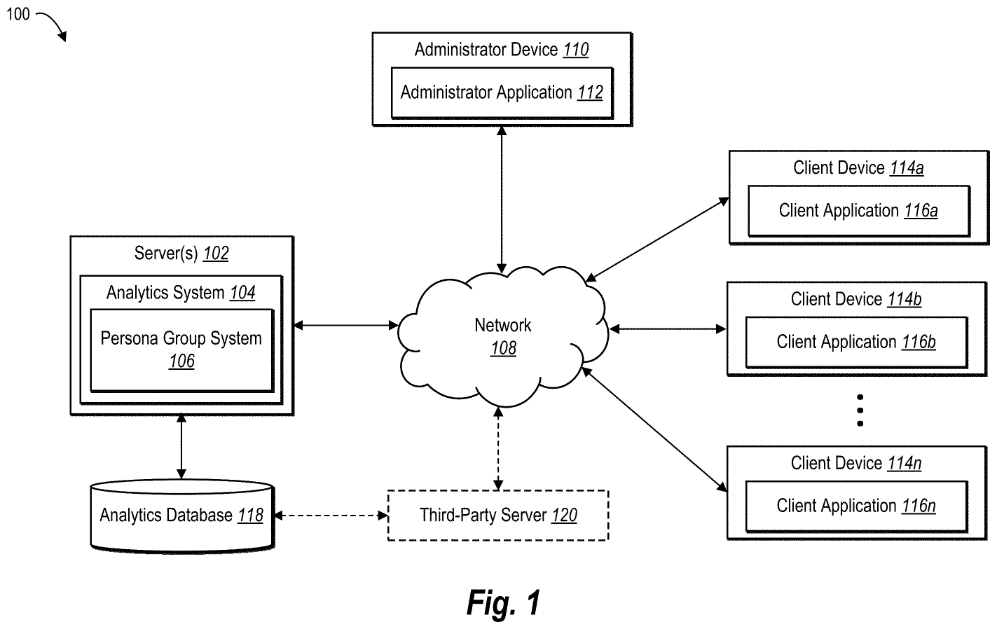

Additional detail will now be provided in relation to illustrative figures portraying example embodiments and implementations of the persona group system. For example, FIG. 1 illustrates a computing system environment (or “environment”) 100 for implementing a persona group system 106 in accordance with one or more embodiments. As shown in FIG. 1, the environment 100 includes server(s) 102, a network 108, an administrator device 110, client devices 114a-114n, an analytics database 118, and optionally a third-party server 120.

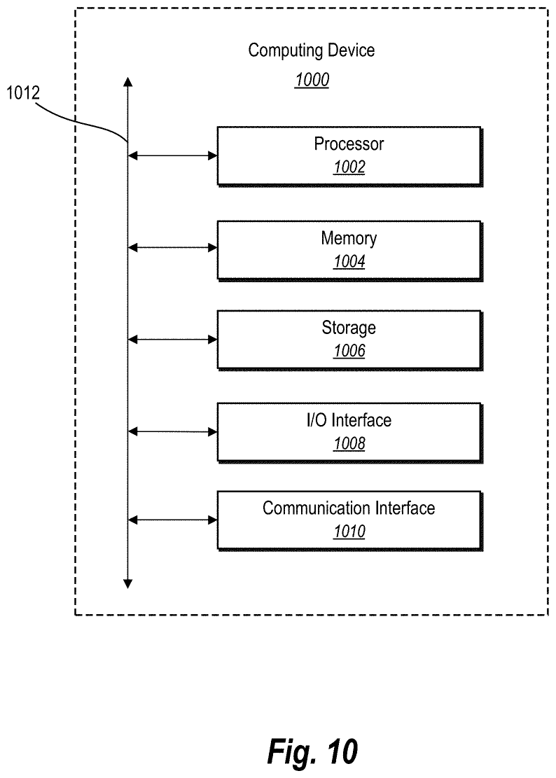

As depicted in FIG. 1, the server(s) 102, the network, 108, the administrator device 110, the client devices 114a-114n, the analytics database 118, and the third-party server 120 are communicatively coupled with each other either directly or indirectly (e.g., through the network 108 discussed in greater detail below in relation to FIG. 10). Additionally, in some embodiments, the server(s) 102, the administrator device 110, the client devices 114a-114n, and the third-party server 120 include a variety of computing devices (including one or more computing devices as discussed in greater detail with relation to FIG. 10).

As mentioned above, the environment 100 includes the server(s) 102. In one or more embodiments, the server(s) 102 generate, store, receive, and/or transmit digital data, including digital data related to digital actions during user sessions. For example, in certain implementations, the server(s) 102 receive (e.g., from the third-party server 120) a digital action log that includes digital actions of a user to execute one or more digital tasks and/or digital workflows. In one or more embodiments, the server(s) 102 comprise a data server. The server(s) 102 can also comprise a communication server or a web-hosting server.

As shown in FIG. 1, the server(s) 102 include an analytics system 104. In particular embodiments, the analytics system 104 collects, manages, and/or utilizes analytics data. For example, the analytics system 104 collects analytics data related to digital actions executed by the client devices 114a-114n. The analytics system 104 collects the analytics data in a variety of ways. For example, in one or more embodiments, the analytics system 104 causes the server(s) 102 to track digital actions performed by users via the client devices 114a-114n and report the digital actions for storage (e.g., in the form of a digital action log) on a database (e.g., the analytics database 118). In some embodiments, the third-party server 120 tracks the digital actions and stores them within the analytics database 118. Accordingly, in certain embodiments, the analytics system 104 retrieves the digital actions tracked by the third-party server 120 from the analytics database 118.

In some embodiments, the analytics system 104 receives the analytics data directly from the client devices 114a-114n. For example, the analytics system 104 provide a user interface through which the client devices 114a-114n execute digital actions. In certain implementations, the user interface comprise an analytics user interface through which the client devices 114a-114n execute digital actions (e.g., to perform data analysis). In some embodiments, the analytics system 104 receives or otherwise detects the digital actions executed by the client devices 114a-114n. Subsequently, in certain implementations, the analytics system 104 stores the digital actions in the analytics database 118.

Additionally, the server(s) 102 include the persona group system 106. In particular, in one or more embodiments, the persona group system 106 identifies a set of digital actions performed by a user from the digital action log. Additionally, for example, the persona group system 106 categorizes subsets of digital actions performed by the user into a set of digital tasks and subsets of digital tasks performed by the user into a set of digital workflows. Subsequently, in one or more embodiments, the persona group system 106 generates a user-activity vector representing frequent digital actions from the set of digital actions, frequent digital tasks from the set of digital tasks, and frequent digital workflows from the set of digital workflows. Additionally, the persona group system 106 determines a persona group for the user by clustering the user-activity vector for the user with additional user-activity vectors for additional users utilizing a clustering model.

In one or more embodiments, the analytics database 118 stores digital data related to digital actions. For example, the analytics database 118 can store digital action logs corresponding to users. Additionally or alternatively to representations or identifiers of the digital actions themselves, in certain implementations, the analytics database 118 stores associated indications of the digital actions (e.g., time stamps, user identifier, session identifier, digital action log identifier, metadata). Though FIG. 1 illustrates the analytics database 118 as a distinct component, one or more embodiments include the analytics database 118 as a component of the server(s) 102, the analytics system 104, or the persona group system 106.

In one or more embodiments, the third-party server 120 tracks, detects, or otherwise identifies digital actions performed by users, via client devices, for the execution of one or more tasks. For example, in one or more embodiments, the third-party server 120 is accessed by a client device (e.g., one of the client devices 114a-114n) to perform digital actions as part of one or more digital tasks or digital workflows. Indeed, like the analytics system 104, the third-party server 120 in certain implementations provides a user interface through which the client devices 114a-114n can execute digital actions (e.g., to perform data analysis or view digital content).

In one or more embodiments, the administrator device 110 includes a computing device that can access and display digital data related to digital actions of users associated with the client devices 114a-114n. For example, the administrator device 110 can include a smartphone, a tablet, a desktop computer, a laptop computer, a head-mounted display device, or another electronic device. Additionally, for instance, the administrator device 110 includes one or more applications (e.g., an administrator application 112) that can access and display digital data related to one or more users (e.g., a graphical visualization or digital recommendation). For example, the administrator application 112 can include a software application installed on the administrator device 110. Additionally, or alternatively, the administrator application 112 can include a software application hosted on the server(s) 102, which may be accessed by the administrator device 110 through another application, such as a web browser.

In one or more embodiments, the client devices 114a-114n include computing devices that perform digital actions (e.g., for execution of one or more digital tasks or digital workflows). For example, the client devices 114a-114n can include smartphones, tablets, desktop computers, laptop computers, head-mounted-display devices, or other electronic devices. Additionally, for instance, the client devices 114a-114n include one or more applications (e.g., client applications 116a-116n, respectively) that can display digital content and/or execute a digital action. For example, the client applications 116a-116n can include a software application respectively installed on the client devices 114a-114n. Additionally, or alternatively, the client applications 116a-116n can include a web browser or other application that accesses a software application hosted on the server(s) 102.

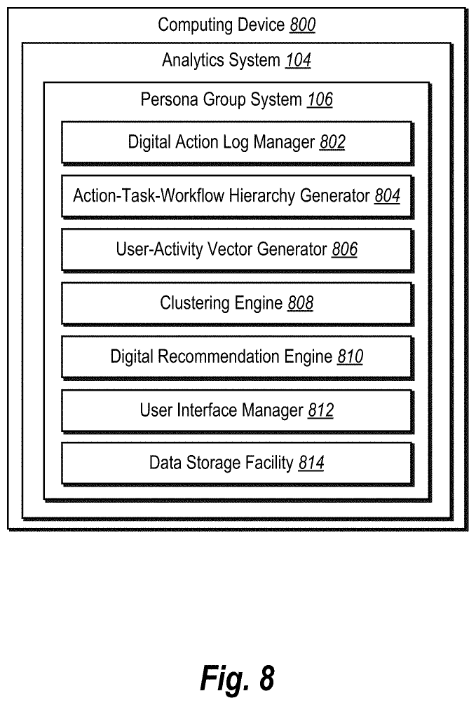

The persona group system 106 can be implemented in whole, or in part, by the individual elements of the environment 100. Indeed, although FIG. 1 illustrates the persona group system 106 implemented with regard to the server(s) 102, different components of the persona group system 106 can be implemented by a variety of devices within the environment 100. For example, one or more (or all) components of the persona group system 106 can be implemented by a different computing device (e.g., one of the client devices 114a-114n or the administrator device 110) or a separate server from the server(s) 102 hosting the analytics system 104 (e.g., the third-party server 120). Example components of the persona group system 106 will be described below with regard to FIG. 8.

Although the environment 100 of FIG. 1 is depicted as having a particular number of components, the environment 100 can have any number of additional or alternative components (e.g., any number of servers, administrator devices, client devices, analytics databases, third-party servers, or other components in communication with the persona group system 106 via the network 108). Similarly, although FIG. 1 illustrates a particular arrangement of the server(s) 102, the network 108, the administrator device 110, the client devices 114a-114n, the analytics database 118, and the third-party server 120, various additional or alternative arrangements are possible.

As mentioned above, the persona group system 106 can identify digital actions from a digital action log and categorize the digital actions into a hierarchy of digital actions, digital tasks, and digital workflows. By generating the hierarchy, in some embodiments, the persona group system 106 determines the frequent digital actions, the frequent digital tasks, and the (frequent) digital workflows for representing in a user-activity vector. Subsequently, the persona group system 106 determines a persona group for the user by clustering distributions of user-activity vectors. In certain implementations, the persona group system 106 generates one or more digital recommendations based on the persona group for the user.

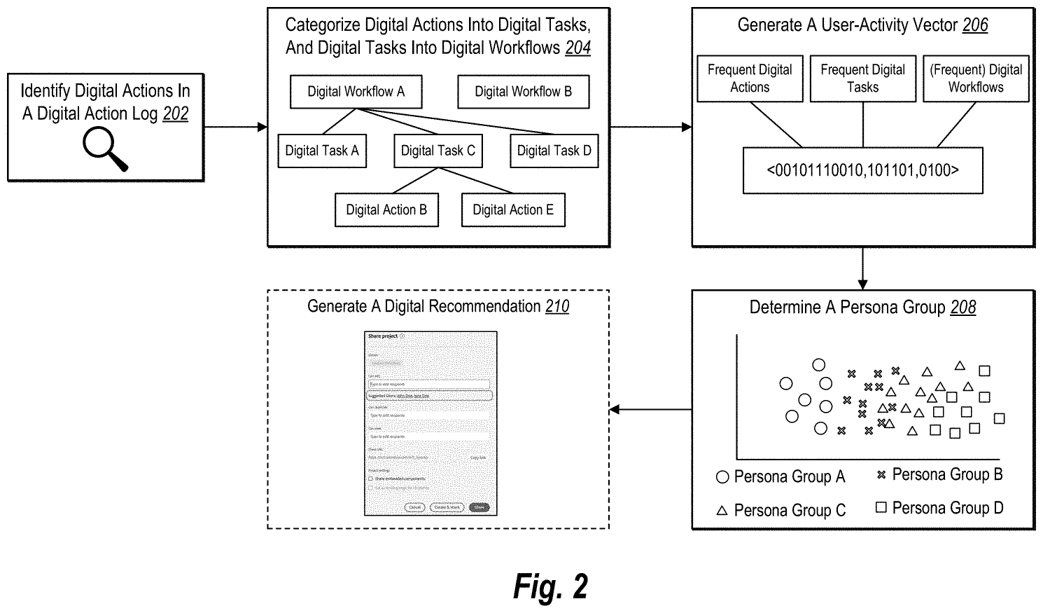

FIG. 2 illustrates the persona group system 106 determining a persona group for a user in accordance with one or more embodiments. At act 202, the persona group system 106 identifies digital actions in a digital action log. In these or other embodiments, the digital action log comprises raw clickstream data, such as a sequence of digital actions executed by a user via a client device. Accordingly, in certain implementations, the persona group system 106 accesses the digital action log to identify digital actions corresponding to one or more user sessions.

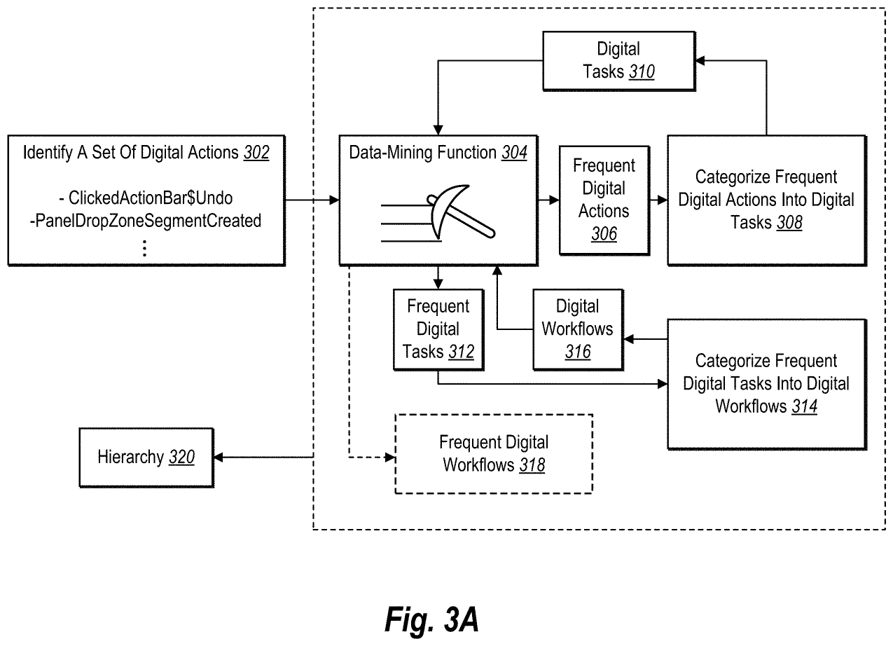

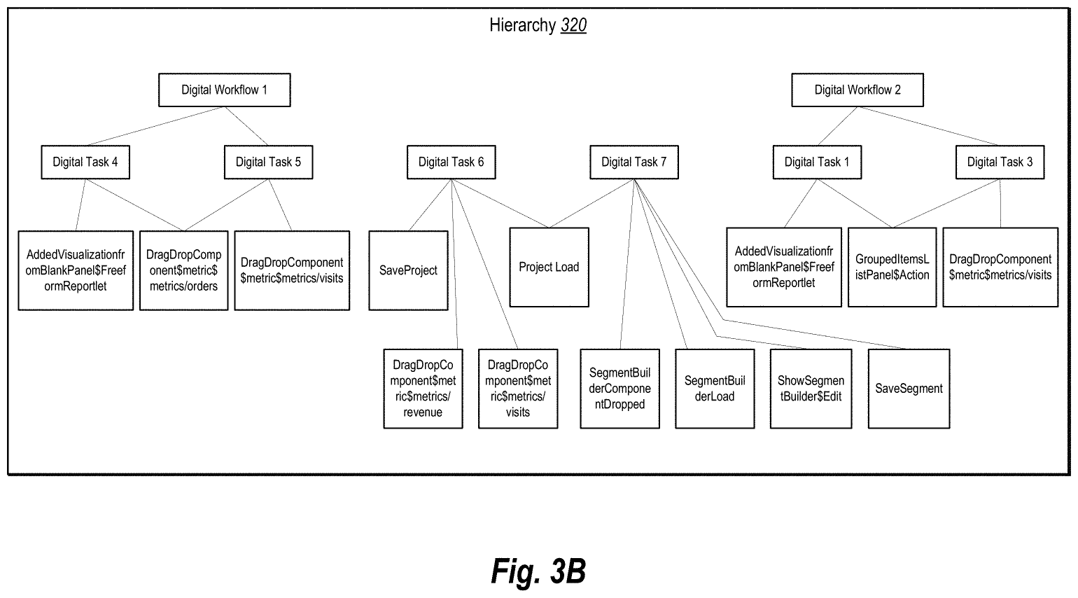

At act 204, the persona group system 106 categorizes digital actions into digital tasks and categorizes digital tasks into digital workflows (e.g., to generate a multi-level hierarchy of session co-occurrences). For example, using the identified digital actions from act 202, the persona group system 106 determines which of the digital actions are frequent digital actions. Additionally, in certain embodiments, the persona group system 106 groups (or associates) subsets of the frequent digital actions to compose digital tasks. Likewise, in some embodiments, the persona group system 106 groups subsets of digital tasks (e.g., frequent digital tasks) to compose digital workflows. Additional detail regarding hierarchy generation is provided below in relation to FIGS. 3A-3B.

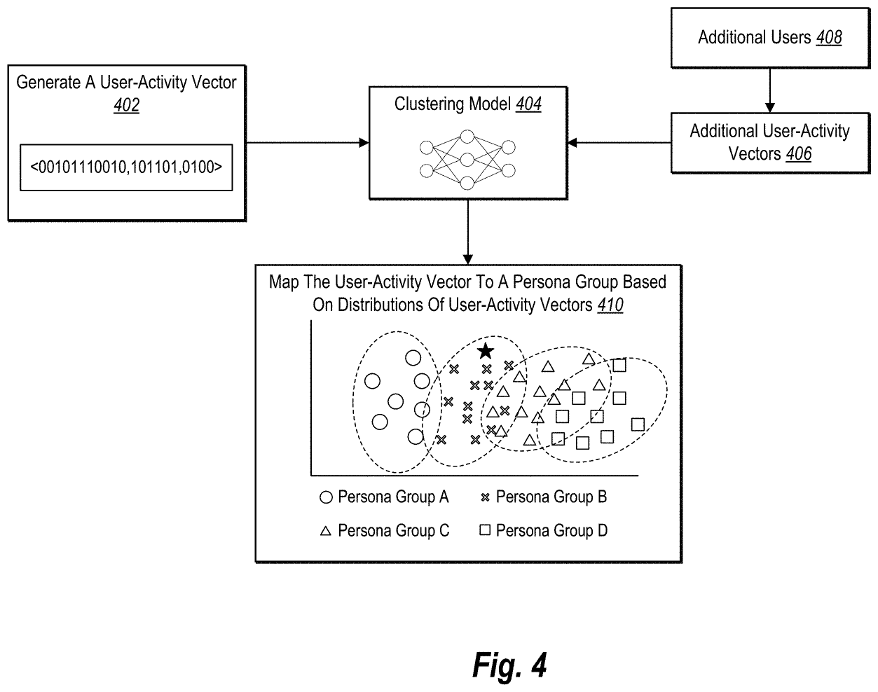

At act 206, the persona group system 106 generates a user-activity vector. In particular embodiments, the persona group system 106 uses frequent digital actions, frequent digital tasks, and digital workflows (e.g., frequent digital workflows) from the multi-level hierarchy to generate a user activity vector. For example, in some embodiments, the persona group system 106 generates a user-activity vector comprising a combination of strings that represent specific digital actions, digital tasks, and digital workflows with binary values of zeros and ones. In this example, zeros (“0”) indicate a digital action, digital task, or digital workflow determined to occur below a frequency threshold. By contrast, ones (“1”) indicate a digital action, digital task, or digital workflow determined to occur at or above a frequency threshold. In other embodiments, however, different methods apply for generating a user-activity vector (e.g., as explained below in relation to FIG. 4).

At act 208, the persona group system 106 determines a persona group for a user. In certain implementations, the persona group system 106 utilizes a clustering model to map the user-activity vector for the user to a particular persona group based on distributions of user-activity vectors (e.g., as also explained below in relation to FIG. 4). For example, depending on how the user-activity vector for the user maps to one or more clusters of other user-activity vectors for additional users, the persona group system 106 makes a probabilistic determination (e.g., a prediction) that the user belongs to a particular persona group.

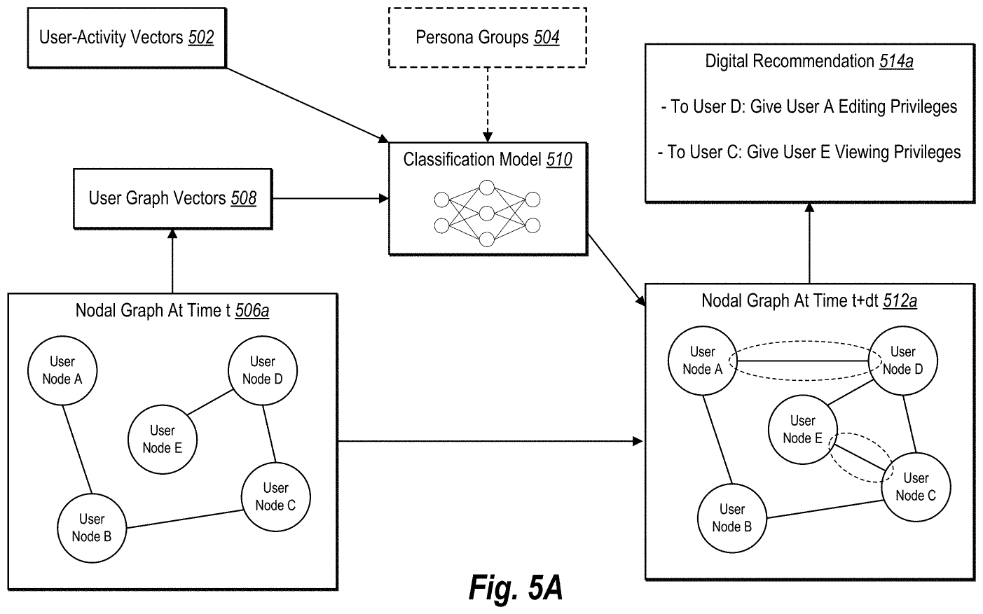

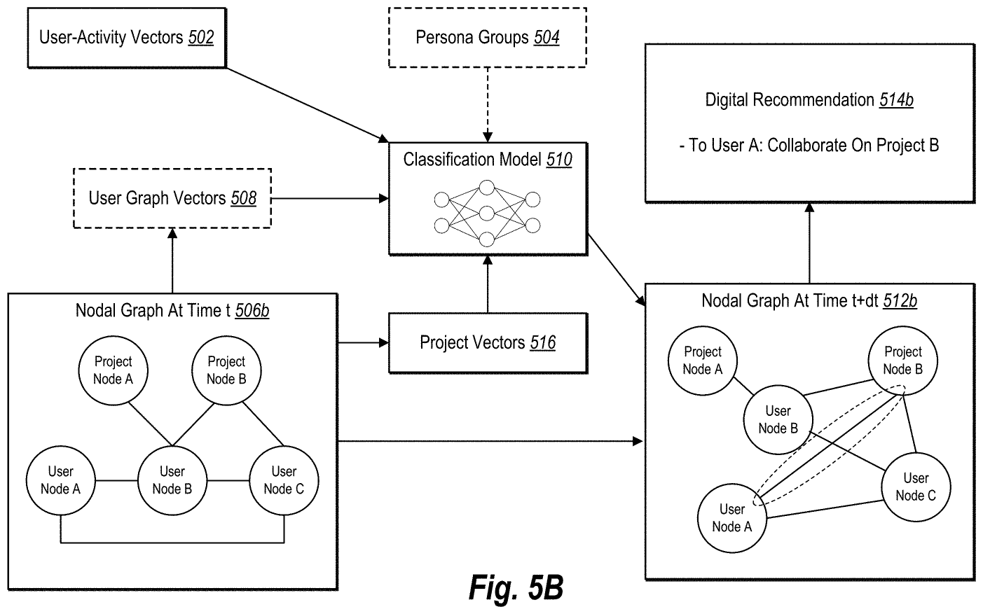

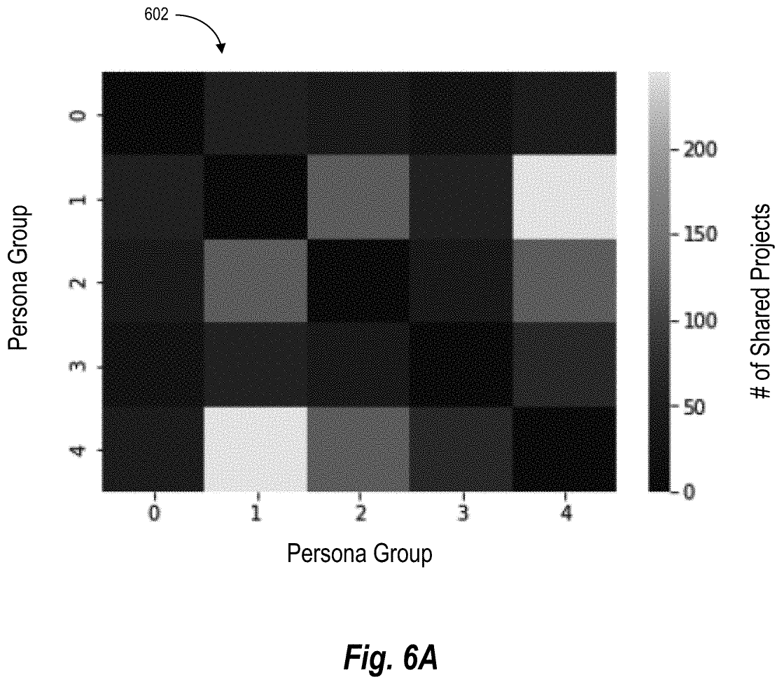

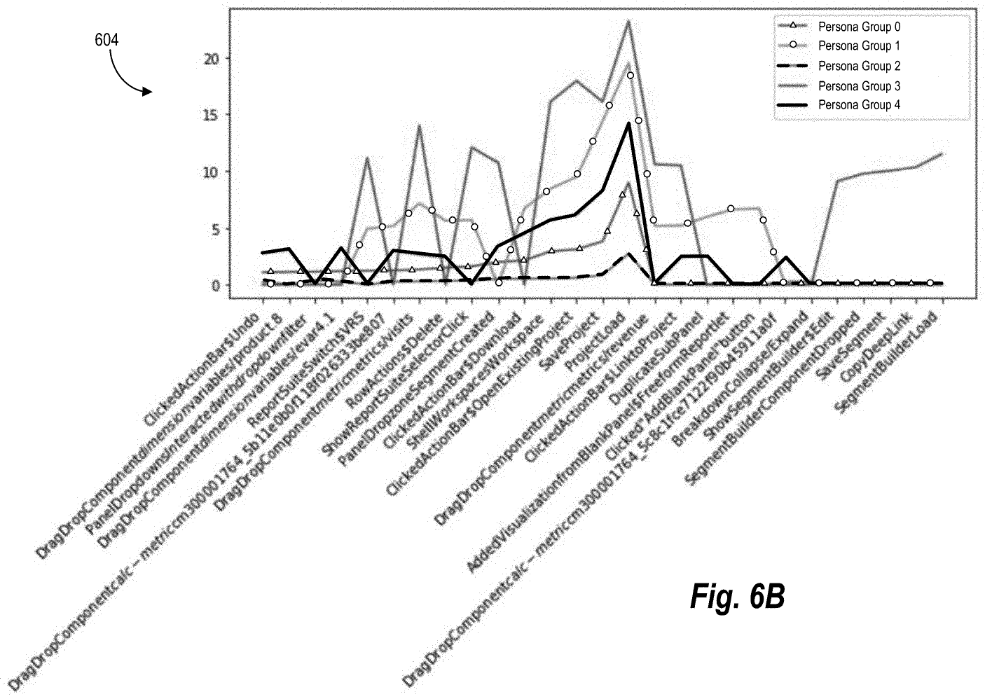

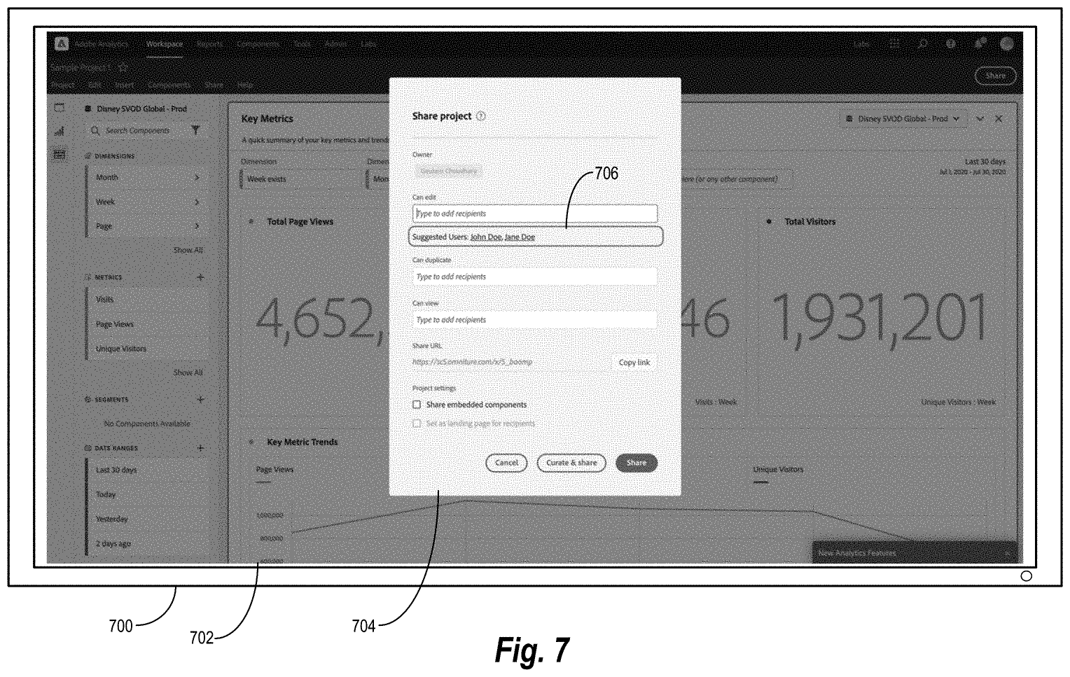

Act 210, the persona group system 106 optionally generates a digital recommendation. In particular embodiments, the persona group system 106 analyzes the persona group for the user and/or the user-activity vector in relation to a nodal graph (e.g., as explained more below in relation to FIGS. 5A-5B). To illustrate, the persona group system 106 uses a classification model to predict a new edge in the nodal graph as an indication that the user will likely work on a particular project or collaborate with a specific user. Subsequently, in some embodiments, the persona group system 106 generates the digital recommendation based on the edge prediction. Examples of digital recommendations are discussed below in relation to FIGS. 6A-6B and FIG. 7.

As mentioned previously, in some embodiments, the persona group system 106 generates a hierarchy comprising frequent digital actions, frequent digital tasks, and digital workflows (e.g., frequent digital workflows). To do so, in certain implementations, the persona group system 106 utilizes a data-mining function as part of a multi-step frequency analysis. FIGS. 3A-3B illustrate the persona group system 106 utilizing a data-mining function 304 to generate a hierarchy 320 in accordance with one or more embodiments.

At act 302, the persona group system 106 identifies a set of digital actions. As discussed in relation to FIG. 2, in certain implementations, the persona group system 106 accesses a digital action log to identify digital actions corresponding to one or more user sessions. To illustrate, the persona group system 106 identifies the digital actions by timestamp in order to assess whether digital actions co-occur within a user session. Accordingly, in certain implementations, the persona group system 106 selects the digital actions that, based on corresponding timestamps, occur at certain times, intervals of times, or between timeout periods (e.g., pauses in user activity) of some threshold period of time.

Myriad other approaches for identifying digital actions are within the scope of the present disclosure (e.g., based on user accounts, user profiles, client device identifiers). For example, in certain implementations, the persona group system 106 identifies digital actions according to their digital action identifiers, such as “ClickedActionBar$Undo,” “SaveSegment,” and “PanelDropZoneSegmentCreated”—to name but a few of the numerous, possible digital action identifiers. To illustrate, in some embodiments, the persona group system 106 performs a semantic evaluation (e.g., a word search) with respect to digital action identifiers to identify a subset of the digital actions having a semantic similarity to the search query. As another example, the persona group system 106 performs various numerical comparisons, vector analyses, decoding processes, etc. for other types of digital action identifiers in order to identify certain digital actions.

In these or other embodiments, digital action identifiers like “ClickedActionBar$Undo” and “PanelDropZoneSegmentCreated” are human-readable labels or textual summaries that represent the digital action corresponding to computer-executable instructions. In some embodiments, the digital action identifiers are user-generated (e.g., hard-coded to be output to a digital action log in response to execution of certain computer-executable instructions for a digital action). In other embodiments, the digital action identifiers are numerical values (e.g., machine-code), hash-values, predicted values, etc. that the persona group system 106 autonomously generates within a digital action log according to, for instance, a machine-learning model.

Based on the identified digital actions, the persona group system 106 utilizes the data-mining function 304 to determine frequent digital actions 306. For example, the data-mining function 304 uses a frequency threshold to assess a frequency of each digital action identified at act 302. If a frequency of a particular digital action satisfies (e.g., meets or exceeds) the frequency threshold, in some embodiments, the persona group system 106 selects the particular digital action as corresponding to the frequent digital actions 306. Conversely, in certain implementations, the persona group system 106 excludes or filters a particular digital action from the frequent digital actions 306 if a frequency of the particular digital action fails to satisfy the frequency threshold.

In these or other embodiments, the data-mining function 304 assesses frequency based on an itemset mining algorithm, such as association rules, the Apriori algorithm, the Park-Chen-Yu (or PCY) algorithm, prefix-tree structure algorithms (also known as FP-tree based algorithms), or association rule mining as described by James Le in An Introduction to Big Data: Itemset Mining, April 2019, archived at medium.com/cracking-the-data-science-interview/an-introduction-to-big-data-itemset-mining-a97a17e0665a (hereafter “Le”); Jong Soo Park, Ming-syan Chen, and Phillip Yu, (1997), An Effective Hash-Based Algorithm for Mining Association Rules In Proceedings of the 1995 ACM SIGMOID international conference on Management of data ACM SIGMOID, archived at dl.acm.org/doi/10.1145/568271.223813 (hereafter “Park et al.”); and Gösta Grahne and Jianfei Zhu in “Efficiently Using Prefix-Trees in Mining Frequent Itemsets,” (2003), In FIMI, Vol. 90, archived at ftp.informatik.rwth-aachen.de/Publications/CEUR-WS/Vol-90/grahne.pdf (hereafter “Grahne et al.”). The contents of Le, Park et al., and Grahne et al. are expressly incorporated herein by reference in their entirety.

At act 308 in FIG. 3A, the persona group system 106 categorizes the frequent digital actions 306 into digital tasks 310. For example, as shown in the hierarchy 320 of FIG. 3B, the persona group system 106 categorizes the frequent digital actions of “GroupedItemsListPanel$Action” and “AddedVisualizationfromBlankPanel$FreeformReportlet” into “Digital Task 1.” Similarly, the persona group system 106 categorizes the frequent digital actions of “DragDropComponent$metric$metrics/orders,” “ProjectLoad,” and “ClickedActionBar$Download” into “Digital Task 2.”

In FIG. 3A, although the act 308 is illustrated separately from the data-mining function 304, the persona group system 106 utilizes the data-mining function 304 to categorize the frequent digital actions 306 into the digital tasks 310. For example, rather than pre-labeling the digital tasks 310 as specific data buckets, the persona group system 106 performs an unsupervised learning approach by utilizing the data-mining function 304 to learn the various subsets of frequent digital actions 306 that respectively correspond to the digital tasks 310. Specifically, in certain implementations, the data-mining function 304 automatically groups the frequent digital actions 306 into the digital action subsets that compose the digital tasks 310 (e.g., “Digital Task 1” through “Digital Task 7”).

By categorizing the frequent digital actions 306 into the digital tasks 310, in some implementations, the persona group system 106 groups subsets of the frequent digital actions 306 according to a discrete computing project or discrete computing job. For instance, each subset of the frequent digital actions 306 comprises frequent digital actions that, when executed in combination, performs or completes the computing project or computing job. For example, the frequent digital actions of FIG. 3B categorized under “Digital Task 2” relate to a particular digital task of downloading an orders report and using menu bar actions. As another example, the frequent digital actions categorized under “Digital Task 6” relate to a particular digital task of loading metrics and monitoring revenue and website visits. In yet another example, the frequent digital actions categorized under “Digital Task 7” relate to a particular digital task of editing an existing user segment and then saving the edited user segment.

In a same or similar manner, the persona group system 106 utilizes the data-mining function 304 to analyze the digital tasks 310 for determining frequent digital tasks 312. For example, in a second analysis step that follows determining the frequent digital actions 306, the persona group system 106 determines which of the digital tasks 310 satisfy a frequency threshold. For those of the digital tasks 310 that satisfy the frequency threshold, in certain implementations, the persona group system 106 selects the digital tasks as corresponding to the frequent digital tasks 312. Otherwise, in certain embodiments, the persona group system 106 excludes or filters a particular digital task from the frequent digital tasks 312 if a frequency of the particular digital task fails to satisfy the frequency threshold.

At act 314 in FIG. 3A, the persona group system 106 categorizes the frequent digital tasks 312 into digital workflows 316 (e.g., by utilizing the data-mining function 304 as mentioned above). For example, as shown in the hierarchy 320 of FIG. 3B, the persona group system 106 categorizes the frequent digital tasks of “Digital Task 4” and “Digital Task 5” into “Digital Workflow 1.” Similarly, the persona group system 106 categorizes the frequent digital tasks of “Digital Task 1” and “Digital Task 3” into “Digital Workflow 2.”

In this manner, in certain embodiments, the persona group system 106 groups subsets of the frequent digital tasks 312 that are frequently performed together (e.g., within a same user session). For instance, the frequent digital tasks of FIG. 3B categorized under “Digital Workflow 1” relate to a particular workflow of loading certain metrics (e.g., website orders and visits) and visualizing the metrics. Similarly, the frequent digital tasks categorized under “Digital Workflow 2” relate to a particular workflow of adding a free-form table to a project and loading a visits metric.

Additionally, in at least some embodiments, the persona group system 106 utilizes the data-mining function 304 to analyze the digital workflows 316 for determining frequent digital workflows 318 (e.g., to represent in a user-activity vector as described more in relation to FIG. 4). For instance, in a third analysis step that follows determining the frequent digital actions 306 and the frequent digital tasks 312, the persona group system 106 determines which of the digital workflows 316 satisfy a frequency threshold. To illustrate, in some embodiments, the persona group system 106 selects the digital workflows satisfying the frequency threshold as corresponding to the frequent digital workflows 318. Additionally or alternatively, the persona group system 106 excludes or filters a particular digital workflow from the frequent digital workflows 318 if a frequency of the particular digital workflow fails to satisfy the frequency threshold.

As provided above, in some embodiments, the persona group system 106 utilizes a clustering model to analyze user-activity vectors. Based on the analysis of the clustering model indicating a representation of persona groups by clusters of user-activity vectors, the persona group system 106 can map the user-activity vector to a persona group. FIG. 4 illustrates the persona group system 106 utilizing a clustering model to cluster user-activity vectors and determine persona groups for users in accordance with one or more embodiments.

At act 402, the persona group system 106 generates a user-activity vector as described above. In particular embodiments, the persona group system 106 generates a vector representation of the frequent digital actions, the frequent digital tasks, and the frequent digital workflows for a user as discussed above in relation to FIGS. 3A-3B.

As mentioned previously, in some embodiments, the persona group system 106 generates a user-activity vector comprising a combination (e.g., concatenation) of strings that represent specific digital actions, digital tasks, and digital workflows with binary values of zeros and ones. For example, in certain embodiments, the persona group system 106 generates a user-activity vector with zeros (“0”) to indicate an individual digital action, an individual digital task, or an individual digital workflow that occurs below a frequency threshold. By contrast, in some embodiments, the persona group system 106 generates a user-activity vector with ones (“1”) to indicate an individual digital action, an individual digital task, or an individual digital workflow that occurs at or above a frequency threshold. To give but one example, the persona group system 106 can generate the user-activity vector in the form of <00101110010,101101,0100>, where each value in the first set of comma-separated values corresponds to a respective digital action, each value in the second set of comma-separated values corresponds to a respective digital task, and each value in the third set of comma-separated values corresponds to a respective digital workflow. Still, in other embodiments, the persona group system 106 uses myriad other ways to generate user-activity vectors that account for specific digital actions, digital tasks, and digital workflows on an individual basis.

In the alternative to binary values, in some embodiments, the persona group system 106 generates a user-activity vector that represents counts of frequent digital actions, frequent digital tasks, and frequent digital workflows (e.g., absolute frequency values of the number of occurrences). For ease of reference, this disclosure will refer to such counts as “frequency counts.”

To illustrate, in certain implementations, the persona group system 106 generates the user-activity vector by aggregating counts of frequent digital actions, frequent digital tasks, and frequent digital workflows. For example, to generate a user-activity vector of the form <#ofFreqDigActions, #ofFreqDigTasks, #ofFreqDigWorkflows >, the persona group system 106 separately aggregates frequency counts. Specifically, the term “#ofFreqDigActions” represents the frequency count or amount of the frequent digital actions, the term “#ofFreqDigTasks” represents the frequency count or amount of the frequent digital tasks, and the term “#ofFreqDigWorkflows” represents the frequency count or amount of the frequent digital workflows. As another example, the persona group system 106 generates the user-activity vector of the form <#ofFreqDigActions+#ofFreqDigTasks+#ofFreqDigWorkflows> by aggregating (e.g., adding “+”) each of the frequency counts to generate a singular frequency count.

As further shown in FIG. 4, the persona group system generates additional user-activity vectors 406 corresponding to additional users 408 in a same or similar manner as just described with respect to FIGS. 3A-3B and the act 402. In such embodiments, the additional users 408 correspond to different users (e.g., other consumers, customers, members, employees, marketing leads) associated with other client devices.

Utilizing the clustering model 404, the persona group system 106 analyzes the user-activity vector for the user from the act 402. In addition, the persona group system 106 analyzes the additional user-activity vectors 406 corresponding to the additional users 408. By utilizing the clustering model 404 to analyze user-activity vectors, the persona group system 106 can identify statistical distributions of user-activity vectors. In particular embodiments, the clustering model 404 assumes multiple unimodal distributions of user-activity vectors to represent different clusters of user-activity vectors.

In these or other embodiments, the clustering model 404 comprises one or more of a Gaussian mixture model, a K-means clustering model, or a Spectral clustering model as respectively described or hyperlinked in John McGonagle, Geoff Pilling, Andrei Dobre, Vincent Tembo, Anvar Kurmukov, Alex Chumbley, Eli Ross, and Jimin Khim, Gaussian Mixture Model, archived at brilliant.org/wiki/gaussian-mixture-model/, (hereafter “McGonagle et al.”); Stuart P. Lloyd, “Least Squares Quantization in PCM,” IEEE Transactions on Information Theory 28.2 (1982): 129-137 (hereafter “Loyd”); and Spectral Clustering, Sci-kit Learn, archived at scikit-learn.org/stable/modules/generated/sklearn.cluster.Spectral Clustering.html, (hereafter “Spectral”). The contents of McGonagle, Loyd, and Spectral are expressly incorporated herein by reference in their entirety. Other examples of the clustering model 404 include connectivity models, centroid models, distribution models, density models, subspace models, group models, graph-based models, signed graph models, neural models, etc.

At act 410, the persona group system 106 uses the clustering model 404 to map the user-activity vector to a persona group based on distributions of user-activity vectors. For example, as shown in FIG. 4, the persona group system 106 maps the user-activity vector (represented as a star) to “Persona Group B.” Specifically, as indicated, the user-activity vector maps to a position within a distribution boundary (e.g., dashed oval lines) that delineate, for instance, two standard deviations, three standard deviations, etc. of a particular modal distribution. Where the particular modal distribution is a cluster of user-activity vectors corresponding to “Persona Group B,” the clustering model 404 can predict with a higher probability that the user-activity vector also corresponds to “Persona Group B.”

In other embodiments not shown in FIG. 4, the clustering model 404 maps the user-activity vector to an overlapping area that corresponds to multiple distributions of user-activity vectors. In these cases, in certain implementations, the persona group system 106 generates multiple predicted persona groups for a user, where each predicted persona group is associated with a persona group probability value. In at least some embodiments, the persona group system 106 selects the persona group corresponding to the highest persona group probability value. Otherwise, in certain cases, if the disparity between persona group probability values fails to satisfy some threshold disparity, the persona group system 106 tunes one or more parameters of the clustering model 404 and iterates the clustering analysis.

To illustrate, in some embodiments, the persona group system 106 uses a tunable parameter k representing the number of clusters of user-activity vectors that indicate persona groups. By adjusting the tunable parameter k, in some embodiments, the persona group system 106 adjusts the quality of clusters (e.g., cluster coherence, cluster separation) and quantity of clusters. Similarly, in some embodiments accounting for domain knowledge in persona groups, the persona group system 106 adjusts the tunable parameter k to provide a more interpretable cluster representation of the persona groups.

Utilizing the above-discussed approaches to generate a hierarchy and user-activity vector, the persona group system 106 can provide a quantitative improvement in clustering quality over conventional clustering systems. For example, as shown in Table 1 below, the persona group system 106 outperforms a conventional clustering system in every instance but one with respect to three particular qualitative measures: the Silhouette Coefficient, the Calinski-Harabasz Index, and the Davies-Bouldin Index. Indeed, with the persona group system 106 utilizing particular clustering models of a Gaussian Mixture Model (GMM), a K-means clustering model, and a Spectral clustering model, the persona group system 106 provides an average improvement in each of the quantitative-measure categories. For example, the persona group system 106 provides an average improvement of 0.18 (200% improvement), 119.74 (368% improvement), and 1.825 (46% improvement when excluding the one instance of 10.27) in each of the respective quantitative-measure categories for clustering quality.

TABLE 1
Quantitative Measures of Clustering Quality

| | | Calinski- | Davies- |
|---|---|---|---|
| | Silhouette | Harabasz | Bouldin |
| | Coefficient | Index | Index |
| | (Higher is | (Higher is | (Lower is |
| Model | better) | better) | better) |
| Conventional System | 0.18 | 44.69 | 3.99 |
| Persona Group | 0.37 | 223.15 | 2.11 |
| System with GMM | | | |
| Persona Group | 0.38 | 224.95 | 2.22 |
| System with K-means | | | |
| Persona Group | 0.33 | 45.20 | 10.27 |
| System with Spectral | | | |

As mentioned above, in some embodiments, the persona group system 106 utilizes a recommendation system that includes a classification model. In certain implementations, the classification model analyzes, user-activity vectors, persona groups, and/or vectors that represent nodal graph information. Based on the analysis, the classification model can predict one or more new edges of the nodal graph that will form over a transition time period. With the edge prediction and/or associated prediction probabilities, in certain embodiments, the persona group system 106 generates one or more corresponding digital recommendations. FIGS. 5A-5B illustrate the persona group system 106 generating a digital recommendation in accordance with one or more embodiments.

As shown in FIG. 5A, the persona group system 106 utilizes a classification model 510 to analyze one or more inputs. In some embodiments, at least one input comprises user-activity vectors 502 (e.g., as generated and described above in relation to the act 402 of FIG. 4). In additional or alternative embodiments, an input comprises persona groups 504 (e.g., as also described above in relation to the determined persona groups in FIG. 4). Further, in certain embodiments, the classification model 510 analyzes another input comprising user graph vectors 508 as a vector representation of a nodal graph 506a at time t.

In some embodiments, the persona group system 106 generates the nodal graph 506a based on digital action logs for a plurality of users. In particular embodiments, each user node represents a user, and each edge connecting two user nodes represents that the connected users share at least one project (e.g., have the same/similar access privileges to a project, collaborate together on a project). For example, based on the digital action logs, the persona group system 106 determines for time t that users corresponding to “User Node A” and “User Node B” share a project, users corresponding to “User Node B” and “User Node C” share a project, users corresponding to “User Node C” and “User Node D” share a project, and users corresponding to “User Node D” and “User Node E” share a project.

Based on the nodal graph 506a, the persona group system 106 generates the user graph vectors 508 for analysis at the classification model 510. To generate the user graph vectors 508, in some embodiments, the persona group system 106 utilizes an algorithm called “node2vec” that creates vector representations of the structural information in the nodal graph 506a. The details of node2vec are described by Aditya Grover and Jure Leskovec, node2vec: Scalable Feature Learning for Networks, In Proceedings of the 22nd ACM SIGKDD International Conference on Knowledge Discovery and Data Mining, 2016 (hereafter “Grover et al.”), the contents of which are expressly incorporated herein by reference in its entirety.

In other embodiments, the persona group system 106 generates the user graph vectors 508 utilizing different approaches. To illustrate a particular embodiment, the persona group system 106 associates each user node with a string of binary values that indicate whether a user shares a project with another user. For example, the persona group system 106 may generate a user graph vector for “User Node A” in relation to each of the User Nodes A-E as follows: <0,1,0,0,0>, where User Nodes A and C-E are associated with values of “0,” and “User Node B” is associated with a value of “1” because “User Node A” and “User Node B” have an edge connection. As described above and below, a user graph or other nodal graph, such as the nodal graphs shown in FIGS. 5A and 5B, includes edges connecting nodes, and the persona group system 106 can use both as bases for generating user graph vector.

Based on at least one of the user-activity vectors 502, the persona groups 504, or the user graph vectors 508, the persona group system 106 utilizes the classification model 510 to predict one or more new edges in a modified nodal graph 512a at time t+dt, where the term dt represents a time period. To illustrate, in certain implementations, the persona group system 106 generates a combined input vector by concatenating a user-activity vector and an additional user-activity vector for an additional user. Based on analyzing the combined input vector, the classification model 510 generates classification probabilities (e.g., probability values that new edges will form between user nodes within a time period dt). For example, in some embodiments, the classification model 510 generates multiple classification probabilities (e.g., one for each combination or pair of unconnected user nodes) to indicate a probability that a user will collaborate with an additional user on a project.

In these or other embodiments, the classification model 510 comprises a linear regression model or a LightGBM model as respectively described and/or hyperlinked in Logistic Regression, Sci-kit Learn, archived at scikit-learn.org/stable/modules/generated/sklearn.linear_model.LogisticRegression.html, (hereafter “Logistic Regression”), and in LightGBM, GitHub, archived at github.com/microsoft/LightGBM (hereafter “LightGBM”). The contents of Logistic Regression and LightGBM are expressly incorporated herein by reference in their entirety. Other examples of classification models include machine-learning models, decision trees, neural networks, etc.

In some embodiments, the classification model 510 predicts a new edge for time t+dt in a modified nodal graph 512a based on the classification probabilities. For example, the classification model 510 may predict a new edge between user nodes based on a classification probability satisfying (e.g., meeting or exceeding) a threshold classification probability. As another example, the classification model 510 may predict a new edge between user nodes based on one or more classification probabilities being higher probability values than other classification probabilities.

In certain embodiments, the classification model 510 predicts a new edge for time t+dt in the modified nodal graph 512a between user nodes of the same or different persona groups. For example, based on a classification probability between “User Node A” for a user in a first persona group and “User Node D” for a user in a second persona group that differs from the first persona group, the classification model 510 may predict a new edge will form between “User Node A” and “User node D.” Similarly, based on a classification probability between “User Node E” for a user in a third persona group and “User node C” for a user also in the third persona group, the classification model 510 may predict a new edge will form between “User Node E” and “User Node C.”

Utilizing the foregoing approaches, the persona group system 106 can quantitatively scores for area under curve-receiver operating characteristic (AUC-ROC) compared to conventional clustering systems and/or conventional analytics recommendation systems. For example, as shown in Table 2 below, the persona group system 106 outperforms conventional clustering systems and/or conventional analytics recommendation systems with respect to using two types of classification models, namely logistic regression and LightGBM. In some embodiments (i.e., the “Persona Group System”) indicated in Table 2, the classification model 510 comprises a logistic regression model or a LightGBM model that respectively perform edge prediction with an AUC-ROC score of 0.781 and 0.870. In these particular embodiments, the classification model 510 analyzes the user-activity vectors 502 (and in some cases, the persona groups 504) but does not analyze the user graph vectors 508.

In other embodiments, (i.e., “node2vec+Persona Group System”) indicated in Table 2, the classification model 510 comprises a logistic regression model or a LightGBM model that respectively perform edge prediction with an AUC-ROC score of 0.823 and 0.983. In these particular embodiments, the classification model 510 analyzes the user-activity vectors 502 and the user graph vectors 508 (and in some cases, the persona groups 504). As shown in Table 2, the various embodiments of the persona group system 106 disclosed herein indeed outperform conventional systems that do not analyze the user-activity vectors 502.

TABLE 2
AUC-ROC scores for user recommendation

AUC-ROC Score

| MODEL FEATURES | Logistic Regression | LightGBM |
|---|---|---|
| node2vec | 0.762 | 0.969 |
| Prior recommendation sys. | 0.602 | 0.693 |
| node2vec + the prior | 0.767 | 0.977 |
| recommendation sys. | | |
| Persona Group System | 0.781 | 0.870 |
| node2vec + Persona Group | 0.823 | 0.983 |
| System | | |

To train the classification model 510 to predict new edges based on at least the user-activity vectors 502 (and in some cases, the persona groups 504 and the user graph vectors 508), in some embodiments, the persona group system 106 uses observed or actual nodal graphs as a type of ground truth data. Then to generate training data, in certain implementations, the persona group system 106 removes one or more edges in the observed nodal graph to create an artificial (e.g., modified) nodal graph that corresponds to a hypothetical previous time step. The persona group system 106 can subsequently predict new edges for the artificial nodal graph and compare with the edges of the observed/actual nodal graph prior to the artificial modification.

In some embodiments, new edges formed over the time step provide positive samples to the classification model 510, and remaining unconnected user nodes provide negative samples to the classification model 510. Based on such positive/negative samples identified in the comparison, in certain embodiments, the persona group system 106 updates one or more parameters of the classification model 510 (e.g., to narrow the difference between predicted edges and actual/observed edges in subsequent training iterations).

As additionally shown in FIG. 5A, the persona group system 106 generates a digital recommendation 514a. For example, based on predicted edges in the modified nodal graph 512a, the persona group system 106 generates the digital recommendation 514a. To illustrate, based on the new predicted edge between “User Node A” and “User Node D,” the persona group system 106 generates a digital recommendation for display within a user interface of a client device for User D to “Give User A Editing Privileges.” Likewise, based on the new predicted edge between “User Node E” and “User Node C,” the persona group system 106 generates a digital recommendation for display within a user interface of a client device for User C to “Give User E Viewing Privileges.”

Additionally or alternatively, the persona group system 106 generates the digital recommendation 514a based on classification probabilities from the classification model 510. For example, the persona group system 106 uses numerical values of the classification probabilities to generate aspects of the digital recommendation 514a. To illustrate, the persona group system 106 may generate a digital recommendation for editing privileges if the classification probability is above a threshold classification probability or else viewing privileges if the classification probability is below the threshold classification probability.

As another example, the persona group system 106 uses the classification probability value from the classification model 510 to determine how and/or where to generate the digital recommendation 514a for display within a user interface. For example, the persona group system 106 may generate the digital recommendation 514a as a prominent pop-up window based on a classification probability that satisfies a threshold classification probability. Otherwise, the persona group system 106 may generate the digital recommendation 514a for display in a less prominent or less visual location of a user interface if a classification probability fails to satisfy a threshold classification probability.

In one or more embodiments, the persona group system 106 generates the digital recommendation 514a as comprising a suggested team of users based on persona groups. For example, the digital recommendation 514a may include a suggested team of users that each belong to a same persona group. As another example, the digital recommendation 514a may include a suggested intra-persona-group collaboration of particular users with respect to a specific project. Conversely, in some embodiments, the digital recommendation 514a includes a suggested team of users from two or more different persona groups. For example, in certain implementations, the digital recommendation 514a comprises a suggested inter-persona-group collaboration of particular users to work on a specific project.

In some embodiments, the digital recommendation 514a comprises personalized content specific to one or more users and/or persona groups. For example, although not shown in FIG. 5A, the digital recommendation 514a may include a suggested digital template that comprises a placeholder document frequently used in a particular persona group to perform a file-save-as operation and make subsequent edits. As another example, the digital recommendation 514a may include a digital notification (e.g., an alert) that indicates a digital event, such as a rise or fall in certain user-specific metrics. Accordingly, in certain implementations, the digital recommendation 514a comprises a suggested team of users to address/remedy the digital event. In yet another example, the digital recommendation 514a comprises a personalized graphical dashboard with one or more user-specific metrics (e.g., to increase productivity/efficiency). Still, in another example, the digital recommendation 514a comprises a suggestion of important/common digital workflows for users to initiate (e.g., by performing some recommended digital action).

As shown in FIG. 5B, the persona group system 106 similarly utilizes the classification model 510 to analyze one or more inputs (e.g., the user-activity vectors 502, the user graph vectors 508, and/or the user graph vectors 508 as described above in relation to FIG. 5A) to predict new edges in a nodal graph. In addition, FIG. 5B shows the persona group system 106 using the classification model 510 to analyze project vectors 516 based on a nodal graph 506b at time t comprising user nodes and project nodes.

In some embodiments, the persona group system 106 generates the nodal graph 506b based on projects and digital action logs for a plurality of users. In particular embodiments, each user node represents a user, and each edge connecting two user nodes represents that the connected users share at least one project (e.g., as described above in relation to FIG. 5A). In addition, each project node represents a project, and each edge connecting a project node and a user node represents a user's access privilege to a project. For example, based on the projects and digital actions logs, the persona group system 106 determines for time t that a user corresponding to “User Node B” has access to projects corresponding to “Project Node A” and “Project Node B.” Similarly, the persona group system 106 determines for time t that a user corresponding to “User Node C” has access to the project corresponding to “Project Node B.”

Based on the nodal graph 506b, the persona group system 106 generates the project vectors 516 for analysis at the classification model 510. To generate the project vectors 516, in some embodiments, the persona group system 106 utilizes the node2vec algorithm described by Grover et al. to create vector representations of the project-structural information in the nodal graph 506b. In other embodiments, the persona group system 106 utilizes a different approach to generate the project vectors 516. For example, in a particular embodiment, the persona group system 106 associates each project node with a string of binary values that indicate whether a user has access to a corresponding project. For example, the persona group system 106 may generate a project vector for “Project Node A” in relation to each of the User Nodes A-C as follows: <0,1,0>, where User Nodes A and C are associated with values of “0,” and “User Node B” is associated with a value of “1” because “Project Node A” and “User Node B” have an edge connection.

Based on at least one of the user-activity vectors 502, the persona groups 504, the user graph vectors 508 or the project vectors 516, the persona group system 106 utilizes the classification model 510 to predict one or more new edges in a modified nodal graph 512b at time t+dt, where the term dt represents a time period after or in addition to time t. To illustrate, in certain implementations, the persona group system 106 generates a combined input vector by concatenating a user-activity vector and at least one of an additional user-activity vector for an additional user or a project vector for a project.

Based on analyzing the combined input vector, the classification model 510 in one or more embodiments generates classification probabilities (e.g., probability values that new edges will form between user nodes and project nodes within a time period dt). For example, in some embodiments, the classification model 510 generates multiple classification probabilities (e.g., one for each combination or pair of unconnected user/project nodes) to indicate a probability that a user will work on a project and therefore need some access privilege. Indeed as shown in FIG. 5B, the persona group system 106 utilizes the classification model 510 to predict a new edge between “User Node A” and “Project Node B.”

Utilizing the approaches just described, the persona group system 106 can recommend projects with improved AUC-ROC scores compared to conventional systems. For example, as shown in Table 3 below, the persona group system 106 outperforms conventional cluster systems and/or conventional analytics recommendation systems with respect to using two types of classification models, namely logistic regression and LightGBM. In some embodiments (i.e., the “Persona Group System”) indicated in Table 3, the classification model 510 comprises a logistic regression model or a LightGBM model that respectively perform edge prediction between user nodes and project nodes with an AUC-ROC score of 0.833 and 0.764. In these particular embodiments, the classification model 510 analyzes the user-activity vectors 502 (and in some cases, the persona groups 504) but does not analyze the user graph vectors 508 or the project vectors 516.

In other embodiments, (i.e., “node2vec+Persona Group System”) indicated in Table 3, the classification model 510 comprises a logistic regression model or a LightGBM model that respectively perform edge prediction between user nodes and project nodes with an AUC-ROC score of 0.823 and 0.714. In these particular embodiments, the classification model 510 analyzes the user-activity vectors 502 and the project vectors 516 (and in some cases, the persona groups 504 and/or the user graph vectors 508). As shown in Table 3, the various embodiments of the persona group system 106 disclosed herein indeed outperform conventional cluster systems and/or conventional analytics recommendation systems that do not analyze the user-activity vectors 502.

TABLE 3
AUC ROC scores for project recommendation

AUC RO Curve

| MODEL FEATURES | Logistic Regression | LightGBM |
|---|---|---|
| node2vec | 0.791 | 0.706 |
| Prior recommendation sys. | 0.810 | 0.760 |
| node2vec + the prior | 0.793 | 0.702 |
| recommendation sys. | | |
| Persona Group System | 0.833 | 0.764 |
| node2vec + Persona Group | 0.823 | 0.714 |
| System | | |

As additionally shown in FIG. 5B, the persona group system 106 generates a digital recommendation 514b (e.g., in a same or similar manner as described above in relation to the digital recommendation 514a of FIG. 5A). For example, based on predicted edges in the modified nodal graph 512b, the persona group system 106 generates the digital recommendation 514b. To illustrate, based on the new predicted edge between “User Node A” and “Project Node B,” the persona group system 106 generates a digital recommendation for display within a user interface of a client device for User A to “Collaborate On Project B.” As another example, the persona group system 106 generates the digital recommendation 514b based directly on classification probabilities from the classification model 510 (e.g., to determine time, place and/or manner of surfacing the digital recommendation 514b in a user interface).

As mentioned above, in some embodiments, the persona group system 106 generates a digital recommendation comprising a graphic visualization. For example, in certain embodiments, the persona group system 106 generates a persona heatmap and/or a frequency plot of digital actions within a graphical user interface as a visual aid to help administrators form teams of users. FIGS. 6A-6B illustrate respective digital recommendations in the form of a persona heat map 602 and a frequency plot 604 in accordance with one or more embodiments. Although depicted as graphics in FIGS. 6A-6B, the administrator device 110 (or another computing device) may likewise display the persona heat map 602 or the frequency plot 604 within a graphical user interface.

As shown in FIG. 6A, the persona group system 106 generates the persona heat map 602 indicating a correlation of inter-persona-group collaboration based on a number of shared projects. For example, Persona Group 1 and Persona Group 4 have over two hundred shared projects between the two persona groups. In addition, Persona Group 2 and Persona Group 4 have about 150 shared projects between each other. Further, Persona Group 3 and Persona Group 4 have about 50 shared projects between each other. Additionally, Persona Group 0 and Persona Group 3 have less than fifty shared projects between each other. In this manner, an administrator can conveniently review a digital recommendation in the form of the persona heat map 602 and quickly form teams according to their determined persona groups.

As shown in FIG. 6B, the persona group system 106 generates the frequency plot 604 comprising a line plot that represents the average frequency of digital actions (e.g., frequent digital actions) by persona group. As indicated, some digital actions correspond to non-overlapping plot lines. For example, Persona Group 1 performs the digital action “Clicked‘AddBlankPanel’button” on average six times during user sessions. In contrast, the other persona groups perform the same digital action on average zero times during user sessions. In this manner, the frequency plot 604 provides indications of non-overlap between persona groups to visually show distinct characteristics between persona groups.

Similarly, the frequency plot 604 in FIG. 6B illustrates some digital actions corresponding to overlapping plot lines. For example, all but Persona Group 3 have overlapping plot lines corresponding to the digital action of “ShowSegmentBuilder$Edit.” This overlapping of plot lines indicates that none of the persona groups (except Persona Group 3) deal with a segment builder tool or otherwise engage in building user segments. Thus, in a similar manner, the frequency plot 604 also provides indications of overlap between persona groups as a visual aid to show which persona groups perform and do not perform certain digital actions. Moreover, the frequency plot 604 can also provide an administrator a birds-eye view of persona groups and their digital actions to inform better team formation.

As discussed above, in some embodiments, the persona group system 106 generates a digital recommendation for presentation within a graphical user interface. FIG. 7 illustrates the persona group system 106 providing a user interface 702 on a computing device 700 depicting a digital recommendation 706 in accordance with one or more embodiments. In these or other embodiments, the computing device 700 comprises a client application (e.g., one of the client applications 116a-116n). In some embodiments, the client application comprises computer-executable instructions that (upon execution) cause the computing device 700 to perform certain actions depicted in the figure, such as presenting a graphical user interface of the client application. Rather than refer to the client application or the persona group system 106 as performing the actions depicted in the figure below, this disclosure will generally refer to the computing device 700 performing such actions for simplicity.

As shown in FIG. 7, the user interface 702 comprises a share-project window 704 with a variety of entry fields pertaining to sharing a project. For example, in response to the computing device 700 detecting a user interaction with a share button or other user interface element, the computing device surfaces the share-project window 704 as shown in FIG. 7.

In addition, FIG. 7 shows the share-project window 704 comprising a digital recommendation 706. For instance, as depicted, the digital recommendation 706 comprises suggested users of “John Doe” and “Jane Doe” as the recipients of editing privileges for the project.

To generate the digital recommendation 706, the computing device 700 performs various acts and algorithms as described above. For example, the computing device 700 identifies digital action logs for “John Doe” and “Jane Doe,” including their respective digital actions performed during one or more user sessions. Subsequently, in certain implementations, the computing device 700 categorizes subsets of digital actions performed by “John Doe” and “Jane Doe” into corresponding sets of digital tasks and categorizes subsets of digital tasks into digital workflows. Using the digital actions, the digital tasks, and the digital workflows, in some cases, the computing device 700 utilizes a data-mining function to determine the frequent digital actions, the frequent digital tasks, and the frequent digital workflows performed by “John Doe” and “Jane Doe.”

Based on the frequent digital actions, the frequent digital tasks, and the frequent digital workflows performed by “John Doe” and “Jane Doe,” in certain implementations, the computing device 700 generates respective user-activity vectors for each user. Then, utilizing a clustering model, the computing device 700 determines a persona group corresponding to “John Doe” and a persona group corresponding to “Jane Doe.” Based on the persona groups for “John Doe” and “Jane Doe,” the computing device 700 generates digital recommendation 706 for display.

Additionally or alternatively, based on user-activity vectors for “John Doe” and “Jane Doe,” in certain implementations, the computing device 700 uses a classification model to predict new edges in a nodal graph connecting user nodes for “John Doe” and “Jane Doe” at a future time period. Similarly, in some embodiments, the computing device 700 uses the classification model to predict new edges based on user graph vectors and/or project vectors representing the nodal graph structure. Based on a new predicted between “John Doe” and “Jane Doe” at a future time period, the computing device 700 generates the digital recommendation 706 as shown in FIG. 7.

In other embodiments not shown, the computing device 700 may generate a version of the digital recommendation 706 that differs from that shown in FIG. 7. For example, in certain implementations, the digital recommendation 706 suggests one or both of “John Doe” or “Jane Doe” (or other users) as the recipients for a different access privilege (e.g., duplicating, viewing). Additionally or alternatively, rather than surfacing the digital recommendation 706 as adjacent to one or more entry fields of the share-project window 704, in some embodiments, the digital recommendation 706 comprises auto-populated fields with suggested users (or projects) contained inside certain entry fields.

Turning to FIG. 8, additional detail will now be provided regarding various components and capabilities of the persona group system 106. In particular, FIG. 8 illustrates an example schematic diagram of a computing device 800 (e.g., the server(s) 102, the administrator device 110, the client devices 114a-114n, and/or the computing device 700) implementing the persona group system 106 in accordance with one or more embodiments of the present disclosure. As shown, the persona group system 106 in one or more embodiments includes a digital action log manager 802, an action-task-workflow hierarchy generator 804, a user-activity vector generator 806, a clustering engine 808, a digital recommendation engine 810, a user interface manager 812, and a data storage facility 814.

The digital action log manager 802 identifies, processes, names, stores, retrieves, transmits, and/or requests digital actions performed by a user (as described in relation to the foregoing figures). In particular embodiments, the digital action log manager 802 identifies digital actions (e.g., a sequence of digital actions) corresponding to one or more user sessions. For example, in some embodiments, the digital action log manager 802 identifies digital actions based on timestamps, digital action identifiers, etc.

The action-task-workflow hierarchy generator 804 categorizes subsets of digital actions performed by the user into a set of digital tasks and subsets of digital tasks performed by the user into a set of digital workflows (as described in relation to the foregoing figures). In particular embodiments, the action-task-workflow hierarchy generator 804 uses a data-mining function to generate a multi-level hierarchy of session co-occurrences by (i) categorizing a set of frequent digital actions performed by the user into a set of digital tasks and (ii) categorizing a set of frequent digital tasks performed by the user into a set of digital workflows. Additionally, in certain embodiments, the action-task-workflow hierarchy generator 804 determines a set of frequent digital workflows for the multi-level hierarchy by using the data-mining function.

The user-activity vector generator 806 generates user-activity vectors (as described in relation to the foregoing figures). In particular embodiments, the user-activity vector generator 806 creates a vector representation of the frequent digital actions, the frequent digital tasks, and the frequent digital workflows. For example, in certain implementations, the user-activity vector generator 806 generates a combination (e.g., concatenation) of strings that represent specific digital actions, digital tasks, and digital workflows with binary values of zeros and ones. Alternatively to binary values, in some embodiments, the user-activity vector generator 806 generates a vector representation of specific digital actions, digital tasks, and digital workflows with frequency counts and/or an aggregation of frequency counts.

The clustering engine 808 determines a persona group for a user based on clusters of user-activity vectors (as described in relation to the foregoing figures). In particular embodiments, the clustering engine 808 utilizes a clustering model to map a user-activity vector to a persona group based on distributions of user-activity vectors. For example, based on a user-activity vector mapping to a particular modal distribution (e.g., cluster) of user-activity vectors, the clustering engine 808 can predict with a certain probability that the user-activity vector corresponds to a particular persona group.

The digital recommendation engine 810 generates, transmits and/or stores digital recommendations (as described in relation to the foregoing figures). In particular embodiments, the digital recommendation engine 810 generates digital recommendations comprising (i) a suggested collaboration between a user and an additional user or (ii) a suggested collaboration of the user on a particular project. In certain embodiments, the digital recommendation engine 810 generates a digital recommendation comprising personalized content specific to a user (e.g., a suggested digital template, a digital notification, or a graphical dashboard with one or more user-specific metrics). Additionally or alternatively, in certain implementations, the digital recommendation engine 810 generates a digital recommendation as comprising a graphic visualization by generating a frequency plot of frequent digital actions across persona groups or a heat map of a number of shared projects between the persona groups.

The user interface manager 812 in one or more embodiments provides, manages, and/or controls a graphical user interface (or simply “user interface”). In particular embodiments, the user interface manager 812 generates and displays a user interface by way of a display screen composed of a plurality of graphical components, objects, and/or elements that allow a user to perform a function. For example, the user interface manager 812 receives user inputs from a user, such as a click/tap to perform a digital action or interact with a digital recommendation. Additionally, the user interface manager 812 in one or more embodiments presents a variety of types of information, including text, digital images, graphical content, or other information for presentation in a user interface (e.g., as part of a digital recommendation).

The data storage facility 814 maintains data for the persona group system 106. The data storage facility 814 (e.g., via one or more memory devices) maintains data of any type, size, or kind, as necessary to perform the functions of the persona group system 106. In particular embodiments, the data storage facility 814 coordinates storage mechanisms for other components of the computing device 800 (e.g., for storing a clustering model and/or a digital action log).

Each of the components of the computing device 800 can include software, hardware, or both. For example, the components of the computing device 800 can include one or more instructions stored on a computer-readable storage medium and executable by processors of one or more computing devices, such as a client device or server device. When executed by the one or more processors, the computer-executable instructions of the persona group system 106 can cause the computing device(s) (e.g., the computing device 800) to perform the methods described herein. Alternatively, the components of the computing device 800 can include hardware, such as a special-purpose processing device to perform a certain function or group of functions. Alternatively, the components of the computing device 800 can include a combination of computer-executable instructions and hardware.

Furthermore, the components of the computing device 800 may, for example, be implemented as one or more operating systems, as one or more stand-alone applications, as one or more modules of an application, as one or more plug-ins, as one or more library functions or functions that may be called by other applications, and/or as a cloud-computing model. Thus, the components of the computing device 800 may be implemented as a stand-alone application, such as a desktop or mobile application. Furthermore, the components of the computing device 800 may be implemented as one or more web-based applications hosted on a remote server.

The components of the computing device 800 may also be implemented in a suite of mobile device applications or “apps.” To illustrate, the components of the computing device 800 may be implemented in an application, including but not limited to ADOBE® ANALYTICS, ADOBE® AUDIENCE MANAGER, ADOBE® EXPERIENCE MANAGER, ADOBE® CAMPAIGN, ADOBE® ADVERTISING CLOUD, ADOBE® TARGET, or ADOBE® COMMERCE CLOUD. Product names, including “ADOBE” and any other portion of one or more of the foregoing product names, may include registered trademarks or trademarks of Adobe Inc. in the United States and/or other countries.

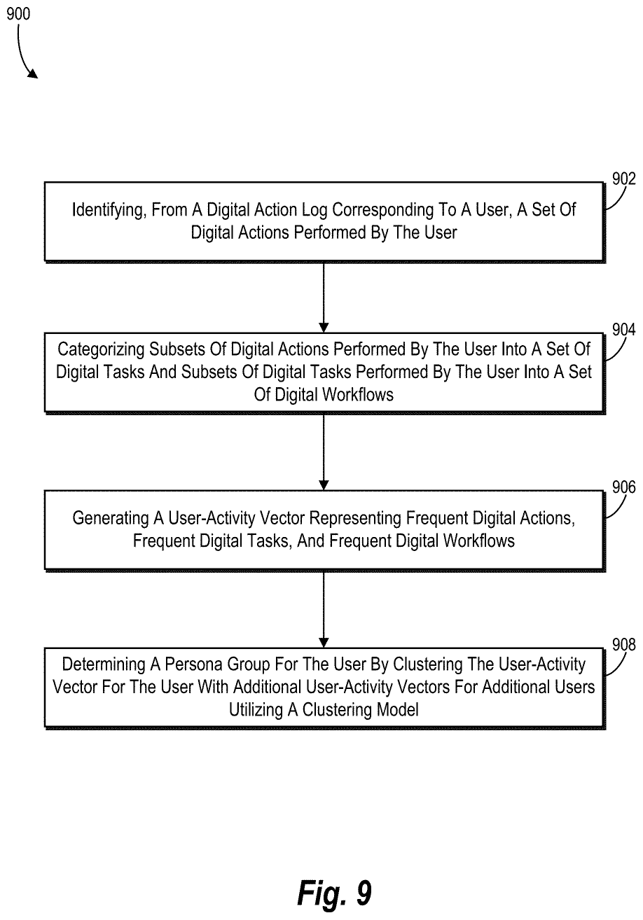

FIGS. 1-8, the corresponding text, and the examples provide several different systems, methods, techniques, components, and/or devices of the persona group system 106 in accordance with one or more embodiments. In addition to the above description, one or more embodiments can also be described in terms of flowcharts including acts for accomplishing a particular result. For example, FIG. 9 illustrates a flowchart of a series of acts 900 for determining a persona group for a user in accordance with one or more embodiments. The persona group system 106 may perform one or more acts of the series of acts 900 in addition to or alternatively to one or more acts described in conjunction with other figures. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In some embodiments, a system can perform the acts of FIG. 9.

As shown, the series of acts 900 includes an act 902 of identifying, from a digital action log corresponding to a user, a set of digital actions performed by the user. In addition, the series of acts 900 comprises an act 904 of categorizing subsets of digital actions performed by the user into a set of digital tasks and subsets of digital tasks performed by the user into a set of digital workflows. In some embodiments, categorizing the subsets of digital actions into the set of digital tasks comprises categorizing the frequent digital actions into the set of digital tasks. Additionally, in certain embodiments, categorizing the subsets of digital tasks into the set of digital workflows comprises categorizing the frequent digital tasks into the set of digital workflows.

Further, the series of acts 900 includes an act 906 of generating a user-activity vector representing frequent digital actions, frequent digital tasks, and frequent digital workflows. As suggested above, the act 906 can include an act 906 generating a user-activity vector representing frequent digital actions from the set of digital actions, frequent digital tasks from the set of digital tasks, and frequent digital workflows from the set of digital workflows. In some embodiments, generating the user-activity vector comprises: determining, utilizing a data-mining function across user sessions from the digital action log, the frequent digital actions from the set of digital actions, the frequent digital tasks from the set of digital tasks, and the frequent digital workflows from the set of digital workflows; and generating the user-activity vector to represent occurrences of the frequent digital actions, the frequent digital tasks, and the frequent digital workflows respectively within the user sessions.

In addition, the series of acts 900 further includes an act 908 of determining a persona group for the user by clustering the user-activity vector for the user with additional user-activity vectors for additional users utilizing a clustering model. In some embodiments, determining the persona group for the user comprises utilizing the clustering model on a set of user-activity vectors comprising the user-activity vector to map the user-activity vector to the persona group based on distributions of the set of user-activity vectors.

It is understood that the outlined acts in the series of acts 900 are only provided as examples, and some of the acts may be optional, combined into fewer acts, or expanded into additional acts without detracting from the essence of the disclosed embodiments. Additionally, the acts described herein may be repeated or performed in parallel with one another or in parallel with different instances of the same or similar acts. As an example of an additional act not shown in FIG. 9, act(s) in the series of acts 900 may include an act of generating, based on the persona group for the user, a digital recommendation for presentation within a graphical user interface. In some embodiments, the digital recommendation comprises at least one of a collaboration between the user and an additional user or a collaboration of the user on a particular project.

As another example of an additional act not shown in FIG. 9, act(s) in the series of acts 900 may include an act of: generating the digital recommendation as a suggested team of users based on persona groups; or generating the digital recommendation as personalized content specific to the user comprising at least one of a suggested digital template, a digital notification, or a graphical dashboard with one or more user-specific metrics.

In yet another example of an additional act not shown in FIG. 9, act(s) in the series of acts 900 may include an act of generating a digital recommendation of a collaboration between the user and an additional user by: generating a nodal graph comprising nodes representing users and edges that link one or more nodes together to represent relationships between users; and determining, utilizing a classification model, a predicted edge between a first node associated with the user and a second node associated with the additional user based on the user-activity vector and the additional user-activity vectors.

Additionally, as another example of an act not shown in FIG. 9, act(s) in the series of acts 900 may include an act of generating a digital recommendation of collaboration on a particular project by: generating a nodal graph comprising nodes representing users, additional nodes representing projects, and edges that link one or more nodes together to represent relationships between users or relationships between the projects and particular users; and determining, utilizing a classification model, a predicted edge between a first node associated with the user and a second node associated with a particular project based on the user-activity vector and project vectors representing the projects.

As a further example of an act not shown in FIG. 9, act(s) in the series of acts 900 may include an act of: identifying, from the digital action log corresponding to the user, a set of digital actions performed by the user during user sessions corresponding to the set of digital actions; and generating, utilizing a data-mining function, a multi-level hierarchy of session co-occurrences by: categorizing a set of frequent digital actions performed by the user into a set of digital tasks; and categorizing a set of frequent digital tasks performed by the user into a set of digital workflows.

In another example of an additional act not shown in FIG. 9, act(s) in the series of acts 900 may include an act of: determining, utilizing the data-mining function, a set of frequent digital workflows from the set of digital workflows; generating a user-activity vector for the user representing occurrences of the set of frequent digital actions, the set of frequent digital tasks, and the set of frequent digital workflows respectively within the user sessions; determining, utilizing the clustering model on user-activity vectors for a set of users, a persona group for the user by mapping the user-activity vector to the persona group based on distributions of the user-activity vectors; and generating, based on the persona group for the user, a digital recommendation for presentation within a graphical user interface.

In yet another example of an additional act not shown in FIG. 9, act(s) in the series of acts 900 may include an act of: identifying the set of frequent digital actions by determining that a subset of digital actions from the set of digital actions satisfy one or more frequency thresholds; and identifying the set of frequent digital tasks by determining that a subset of digital tasks from the set of digital tasks satisfy the one or more frequency thresholds.

Additionally, as another example of an act not shown in FIG. 9, act(s) in the series of acts 900 may include an act of generating the digital recommendation for presentation within the graphical user interface on an administrator device by generating a graphic visualization comprising a frequency plot of the set of frequent digital actions across persona groups or a heat map of a number of shared projects between the persona groups.

As a further example of an additional act not shown in FIG. 9, act(s) in the series of acts 900 may include an act of: generating a combined input vector by concatenating the user-activity vector and at least one of an additional user-activity vector for an additional user or a project vector for a project; generating one or more classification probabilities that the user will collaborate with the additional user or work on the project by utilizing a classification model to analyze the combined input vector; and based on the one or more classification probabilities, generating the digital recommendation.

In another example of an additional act not shown in FIG. 9, act(s) in the series of acts 900 may include an act of generating the digital recommendation by: generating a nodal graph comprising nodes representing users and edges that link one or more nodes together to represent a relationship between users; generating one or more user graph vectors that represent a structure of the nodes and the edges within the nodal graph; and determining, utilizing a classification model, a predicted edge between a first node associated with the user and a second node associated with an additional user based on the user-activity vectors for the set of users, the user-activity vector for the user, and the user graph vectors.

In yet another example of an additional act not shown in FIG. 9, act(s) in the series of acts 900 may include an act of generating the digital recommendation by: generating, for an initial time period, a nodal graph comprising nodes representing users and edges that link one or more nodes together to represent relationships between users; and determining, utilizing a classification model, a predicted edge within a modified nodal graph at a subsequent time period between a first node associated with the user and a second node associated with an additional user based on the user-activity vector and the user-activity vectors for the set of users.

Additionally, as another example of an act not shown in FIG. 9, act(s) in the series of acts 900 may include an act of generating the digital recommendation by: generating a suggested intra-persona-group collaboration between the user and a first additional user within the persona group of the user; or generating a suggested inter-persona-group collaboration between the user and a second additional user outside the persona group of the user.

As a further example of an additional act not shown in FIG. 9, act(s) in the series of acts 900 may include an act of: categorizing the set of frequent digital actions into the set of digital tasks by categorizing a set of frequently co-occurring digital actions performed by the user during particular user sessions into the set of digital tasks; and categorizing the set of frequent digital tasks into the set of digital workflows by categorizing a set of frequently co-occurring digital tasks performed by the user during the particular user sessions into the set of digital workflows.

In another example of an additional act not shown in FIG. 9, act(s) in the series of acts 900 may include an act of generating the digital recommendation by providing, for display within a graphical user interface, a suggestion of one or more additional users to grant edit privileges, duplicating privileges, or viewing privileges with respect to a project.

Additionally, as another example of an act not shown in FIG. 9, act(s) in the series of acts 900 may include an act of: generating one or more classification probabilities that the two or more users will collaborate on a particular project by utilizing a classification model to analyze the user-activity vectors; and based on the one or more classification probabilities, recommend the particular project to the two or more users.

In the alternative to some or all of the act(s) in the series of acts 900, the persona group system 106 may perform a method of: identifying digital action logs corresponding to a set of users of an organization; performing a step for determining frequent digital actions, frequent digital tasks, and frequent digital workflows performed by respective users from the set of users based on the digital action logs; generating user-activity vectors for the set of users representing the frequent digital actions, the frequent digital tasks, and the frequent digital workflows performed by the respective users; determining persona groups for the set of users by clustering particular user-activity vectors into the persona groups utilizing a clustering model; and generating, based on the persona groups for the set of users, a digital recommendation concerning a collaboration between two or more users of the organization for presentation within a graphical user interface.

As just mentioned, in one or more embodiments, act(s) can include performing a step for determining frequent digital actions, frequent digital tasks, and frequent digital workflows performed by respective users from the set of users based on the digital action logs. For instance, the acts and algorithms described above in relation to FIG. 3A can comprise the corresponding acts (or structure) for performing a step for determining frequent digital actions, frequent digital tasks, and frequent digital workflows performed by respective users from the set of users based on the digital action logs.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., the server(s) 102, the administrator device 110, the client devices 114a-114n, and/or the computing devices 700-800). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of the computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable storage medium comprising instructions that, when executed by at least one processor, cause a computing device to:
identify, from a digital action log corresponding to a user, a set of digital actions performed by the user;
categorize subsets of digital actions performed by the user into a set of digital tasks and subsets of digital tasks performed by the user into a set of digital workflows;
generate a user-activity vector representing frequent digital actions from the set of digital actions, frequent digital tasks from the set of digital tasks, and frequent digital workflows from the set of digital workflows; and
determine a persona group for the user by clustering the user-activity vector for the user with additional user-activity vectors for additional users utilizing a clustering model.

2. The non-transitory computer-readable storage medium of claim 1, further comprising instructions that, when executed by the at least one processor, cause the computing device to generate, based on the persona group for the user, a digital recommendation for presentation within a graphical user interface.

3. The non-transitory computer-readable storage medium of claim 2, further comprising instructions that, when executed by the at least one processor, cause the computing device to generate the digital recommendation comprising at least one of a collaboration between the user and an additional user or a collaboration of the user on a particular project.

4. The non-transitory computer-readable storage medium of claim 2, further comprising instructions that, when executed by the at least one processor, cause the computing device to:
generate the digital recommendation as a suggested team of users based on persona groups; or
generate the digital recommendation as personalized content specific to the user comprising at least one of a suggested digital template, a digital notification, or a graphical dashboard with one or more user-specific metrics.

5. The non-transitory computer-readable storage medium of claim 1, further comprising instructions that, when executed by the at least one processor, cause the computing device to generate a digital recommendation of a collaboration between the user and an additional user by:
generating a nodal graph comprising nodes representing users and edges that link one or more nodes together to represent relationships between users; and
determining, utilizing a classification model, a predicted edge between a first node associated with the user and a second node associated with the additional user based on the user-activity vector and the additional user-activity vectors.

6. The non-transitory computer-readable storage medium of claim 1, further comprising instructions that, when executed by the at least one processor, cause the computing device to generate a digital recommendation of collaboration on a particular project by:
generating a nodal graph comprising nodes representing users, additional nodes representing projects, and edges that link one or more nodes together to represent relationships between users or relationships between the projects and particular users; and
determining, utilizing a classification model, a predicted edge between a first node associated with the user and a second node associated with a particular project based on the user-activity vector and project vectors representing the projects.

7. The non-transitory computer-readable storage medium of claim 1, further comprising instructions that, when executed by the at least one processor, cause the computing device to:
categorize the subsets of digital actions into the set of digital tasks by categorizing the frequent digital actions into the set of digital tasks; and
categorize the subsets of digital tasks into the set of digital workflows by categorizing the frequent digital tasks into the set of digital workflows.

8. The non-transitory computer-readable storage medium of claim 1, further comprising instructions that, when executed by the at least one processor, cause the computing device to generate the user-activity vector by:
determining, utilizing a data-mining function across user sessions from the digital action log, the frequent digital actions from the set of digital actions, the frequent digital tasks from the set of digital tasks, and the frequent digital workflows from the set of digital workflows; and
generating the user-activity vector to represent occurrences of the frequent digital actions, the frequent digital tasks, and the frequent digital workflows respectively within the user sessions.

9. The non-transitory computer-readable storage medium of claim 1, further comprising instructions that, when executed by the at least one processor, cause the computing device to determine the persona group for the user by utilizing the clustering model on a set of user-activity vectors comprising the user-activity vector to map the user-activity vector to the persona group based on distributions of the set of user-activity vectors.

10. A system comprising:
one or more memory devices comprising a clustering model and a digital action log corresponding to a user; and
one or more processors configured to cause the system to:
identify, from the digital action log corresponding to the user, a set of digital actions performed by the user during user sessions corresponding to the set of digital actions;
generate, utilizing a data-mining function, a multi-level hierarchy of session co-occurrences by:
categorizing a set of frequent digital actions performed by the user into a set of digital tasks; and
categorizing a set of frequent digital tasks performed by the user into a set of digital workflows;
determine, utilizing the data-mining function, a set of frequent digital workflows from the set of digital workflows;
generate a user-activity vector for the user representing occurrences of the set of frequent digital actions, the set of frequent digital tasks, and the set of frequent digital workflows respectively within the user sessions;
determine, utilizing the clustering model on user-activity vectors for a set of users, a persona group for the user by mapping the user-activity vector to the persona group based on distributions of the user-activity vectors; and
generate, based on the persona group for the user, a digital recommendation for presentation within a graphical user interface.

11. The system of claim 10, wherein the one or more processors are further configured to cause the system to:
identify the set of frequent digital actions by determining that a subset of digital actions from the set of digital actions satisfy one or more frequency thresholds; and
identify the set of frequent digital tasks by determining that a subset of digital tasks from the set of digital tasks satisfy the one or more frequency thresholds.

12. The system of claim 10, wherein the one or more processors are further configured to cause the system to generate the digital recommendation for presentation within the graphical user interface on an administrator device by generating a graphic visualization comprising a frequency plot of the set of frequent digital actions across persona groups or a heat map of a number of shared projects between the persona groups.

13. The system of claim 10, wherein the one or more processors are further configured to cause the system to:
generate a combined input vector by concatenating the user-activity vector and at least one of an additional user-activity vector for an additional user or a project vector for a project;
generate one or more classification probabilities that the user will collaborate with the additional user or work on the project by utilizing a classification model to analyze the combined input vector; and
based on the one or more classification probabilities, generate the digital recommendation.

14. The system of claim 10, wherein the one or more processors are further configured to cause the system to generate the digital recommendation by:
generating a nodal graph comprising nodes representing users and edges that link one or more nodes together to represent a relationship between users;
generating one or more user graph vectors that represent a structure of the nodes and the edges within the nodal graph; and
determining, utilizing a classification model, a predicted edge between a first node associated with the user and a second node associated with an additional user based on the user-activity vectors for the set of users, the user-activity vector for the user, and the user graph vectors.

15. The system of claim 10, wherein the one or more processors are further configured to cause the system to generate the digital recommendation by:
generating, for an initial time period, a nodal graph comprising nodes representing users and edges that link one or more nodes together to represent relationships between users; and
determining, utilizing a classification model, a predicted edge within a modified nodal graph at a subsequent time period between a first node associated with the user and a second node associated with an additional user based on the user-activity vector and the user-activity vectors for the set of users.

16. The system of claim 10, wherein the one or more processors are further configured to cause the system to generate the digital recommendation by:
generating a suggested intra-persona-group collaboration between the user and a first additional user within the persona group of the user; or
generating a suggested inter-persona-group collaboration between the user and a second additional user outside the persona group of the user.

17. The system of claim 10, wherein the one or more processors are further configured to cause the system to:
categorize the set of frequent digital actions into the set of digital tasks by categorizing a set of frequently co-occurring digital actions performed by the user during particular user sessions into the set of digital tasks; and
categorize the set of frequent digital tasks into the set of digital workflows by categorizing a set of frequently co-occurring digital tasks performed by the user during the particular user sessions into the set of digital workflows.

18. The system of claim 10, wherein the one or more processors are further configured to cause the system to generate the digital recommendation by providing, for display within a graphical user interface, a suggestion of one or more additional users to grant edit privileges, duplicating privileges, or viewing privileges with respect to a project.

19. A computer-implemented method comprising:
identifying digital action logs corresponding to a set of users of an organization;
performing a step for determining frequent digital actions, frequent digital tasks, and frequent digital workflows performed by respective users from the set of users based on the digital action logs;
generating user-activity vectors for the set of users representing the frequent digital actions, the frequent digital tasks, and the frequent digital workflows performed by the respective users;
determining persona groups for the set of users by clustering particular user-activity vectors into the persona groups utilizing a clustering model; and
generating, based on the persona groups for the set of users, a digital recommendation concerning a collaboration between two or more users of the organization for presentation within a graphical user interface.

20. The computer-implemented method of claim 19, wherein generating the digital recommendation comprises:
generating one or more classification probabilities that the two or more users will collaborate on a particular project by utilizing a classification model to analyze the user-activity vectors; and
based on the one or more classification probabilities, recommend the particular project to the two or more users.
